(19) United States
(12) Patent Application Publication
(10) Pub. No.: US 2020/0097915 A1
(43) Pub. Date: Mar. 26, 2020

(54) SUPPORT SYSTEM, SERVER DEVICE, AND SUPPORT METHOD

(71) Applicant: SHASHOKU SYSTEM CO., LTD., Osaka-shi, Osaka (JP)

(72) Inventor: Kazuya YAMANAKA, Osaka-shi, Osaka (JP)

(73) Assignee: SHASHOKU SYSTEM CO., LTD., Osaka-shi, Osaka (JP)

(21) Appl. No.: 16/497,002

(22) PCT Filed: Feb. 22, 2018
(86) PCT No.: PCT/JP2018/006441

§ 371 Date: Nov. 22, 2019

(30) Foreign Application Priority Data
Mar. 24, 2017 (JP) 2017-059630

(51) Int. Cl. G06Q 10/10; G06Q 30/02

(52) U.S. Cl. CPC G06Q 10/109; G06Q 30/0283

(57) ABSTRACT

A service provider terminal obtains, from a user, a user identifier of the user, sends the user identifier, a service amount, and a service provider identifier to a server device. The server device stores the user identifier and subsidy calculation information in correlation with each other in advance. The server device determines whether to subsidize the predetermined item or service based on a time at which the pieces of data are received. When it is determined that the predetermined item or service is to be subsidized, the server device calculates the amount of subsidy by using the received service amount and the subsidy calculation information stored in correlation with the received user identifier. The server device sends, to the service provider terminal, the calculated amount of subsidy or a payment amount obtained by subtracting the calculated amount of subsidy from the received service amount.

### TECHNICAL FIELD

The present invention relates to a system for supporting employee benefits services that a company or the like offers to their staff, for example.

### BACKGROUND ART

Many companies have recently enhanced employee benefits in the hope of keeping and retaining their staff, and of increasing the incentive for the staff to work. Some companies provide a so-called cafeteria benefits plan which allows staff members to select among a variety of offerings of employee benefits and to use the same according to preference of each of the staff members.

In view of this, a technology for implementing such a cafeteria benefits plan has been proposed. According to the technology, a cafeteria benefits plan surrogate device manages points of workers, makes a reservation of a facility in response to application for use from a worker to update the points of the worker. When using the facility, the worker pays a self-payment amount depending on the point, and the remaining balance is billed to the company through the cafeteria benefits plan surrogate device (Patent Literature 1).

Examples of the employee benefits include a company cafeteria. The company cafeteria is a facility offering meals for the convenience of relevant parties such as employees of business places. The facility offers low-cost meals, and is installed at a business place. More and more companies improve their company cafeteria in response to a recent increase in health consciousness. For example, a company cafeteria offers a variety of low-calorie and low-sodium menus, extends business hours, or increases the area of the cafeteria.

### CITATION LIST

### Patent Literature

Patent Literature 1: 1)2004-102761A

### SUMMARY OF INVENTION

### Technical Problem

However, in order to install a company cafeteria, it is necessary that a business place has a certain space and has many employees using the cafeteria. For this reason, a company cafeteria is installed in a corporation, namely, large company, in many cases.

In contrast, employee benefits services related to food are often offered insufficiently in: smaller companies that have difficulty in allocating a space or budget for installing a company cafeteria; companies that have difficulty in consolidating a plurality of small business places; and companies having few advantages to install a company cafeteria because most employees are out of the office during mealtime.

If the technology of Patent Literature 1 is applied to lunch, employees are required to decide, in advance, a restaurant for lunch every day and to apply in advance to use the restaurant. This is too laborious to be practical.

Aside from such a company cafeteria, another example of the employee benefits is a facility that is preferably used by an employee, when he/she has time, without reservations in advance. Such a facility is, for example, a gymnasium.

With this being the situation, an object of an embodiment of the present invention is to offer highly convenient employee benefits services to staff.

### Solution to Problem

A support system according to an aspect of the present invention is a support system including a service provider terminal owned by a service provider that provides a user with a predetermined item or service, and a server device configured to perform communication with the service provider terminal. The service provider terminal includes an obtaining means configured to obtain, from the user, a user identifier for identifying the user, and a first transmission means configured to send, to the server device, the user identifier obtained by the obtaining means, a service amount that is a price of the predetermined item or service, and a service provider identifier for identifying the service provider. The server device includes a first storage means configured to store the user identifier and subsidy calculation information in correlation with each other in advance, and a second transmission means configured to calculate, in response to the user identifier, the service amount, and the service provider identifier received from the service provider terminal, an amount of subsidy by using the received service amount and the subsidy calculation information stored in correlation with the received user identifier in the first storage means, and send, to the service provider terminal, the calculated amount of subsidy or a payment amount obtained by subtracting the calculated amount of subsidy from the received service amount.

According to the support system having such a configuration, as long as the service provider obtains an identifier for identifying a user (employee), it is possible to find the amount of subsidy that a user can receive, or a payment amount calculated by subtracting the subsidy amount from a service amount. This allows the user to find the amount of subsidy when he/she pays the service amount. Alternatively, this allows the user to receive subsidy automatically in response to the payment amount paid.

For example, it is supposed that the user is an employee of a company and the service provider is a restaurant in a town. Even when the employee has a meal, in his/her preferred restaurant, the system allows the employee to have a subsidized meal. Stated differently, even if the company does not install a company cafeteria, the company can provide employees with an employee benefits service similar to that for the case where a company cafeteria is installed in the company. Alternatively, if the service provider is a bento (meal packed in a box) place in a town, and if the employee buys a packed meal at the bento place, he/she can receive subsidy. Yet alternatively, if the service provider is a so-called convenience store, supermarket, department store, or the like, and if the employee buys his/her preferred packed meal or bread at such a shop or store, he/she can buy a subsidized packed meal or bread. Yet alternatively, if the service provider uses a vending machine having a function as the service provider terminal to sell drinking water and so on, the employee can buy his/her preferred subsidized drinking water and so on.

The support system may be provided with a subsidy determination means configured to determine, in response to the user identifier, the service amount, and the service provider identifier received from the service provider terminal, whether to subsidize the predetermined item or service based on a time at which the pieces of data are received. The second transmission means may send the foregoing pieces of information to the service provider terminal when the subsidy determination means determine the predetermined item or service to be subsidized.

This configuration makes it possible to limit, to an intended time, a time at which to use employee benefits services to be subsidized in a company and so on.

In conventional methods, when a company intends to subsidize lunch, installing a company cafeteria is conceivable. To be specific, a company cafeteria is installed within the company and meals are offered at lunchtime at a price lower than that of ordinary cafeterias/restaurants because of subsidy from the company. However, some staff members can have meals in a company cafeteria while other staff members cannot have meals therein, which leads to unfair situations. If staff members who cannot have meals in the company cafeteria receive subsidy for meals, they are supposed to receive subsidy also for meals except for lunchtime substantially. This causes an unfair situation between staff members who have lunch at the company cafeteria and staff members who cannot have lunch at the company cafeteria.

However, as compared to the case of conventional methods, this configuration reduces a sense of unfairness between staff members.

In the support system described above, it is preferable that: the first storage means store, in correlation with the user identifier, an organization identifier for identifying an organization to which a user indicated by the user identifier belongs; and the server device further includes a second storage means configured to store, in correlation with the service amount and the amount of subsidy, the user identifier and the service provider identifier received from the service provider terminal, and a total calculation means configured to calculate, for each organization identifier, an organization subsidy total amount that is a total amount of the subsidy stored in correlation and an organization list price total amount that is a total of service amounts, and calculate, for each service provider identifier, a provider subsidy total amount that is a total amount of the subsidy stored in correlation and a provider list price total amount that is a total of service amounts.

According to this configuration, the organization that the user is in is stored, and information on services that the service provider has provided to the user (user identifier, service provider identifier, service amount, and subsidy amount) is stored. This enables calculation of a total of service amounts and a total of subsidy amounts for each organization that the user is in and for each service provider. This allows, for example, each organization to easily find the amount of subsidy that has been given as employee benefits, and each service provider to find a rate of the subsidy to sales.

In the support system described above, it is preferable that the server device further includes a settlement means configured to calculate an organization handling charge in accordance with each of the organization list price total amounts, add the organization handling charge to the organization subsidy total amount to calculate a billing amount to be billed to an organization indicated by each of the organization identifiers, calculate a provider handling charge in accordance with each of the provider list price total amounts, and subtract the provider handling charge from the provider subsidy total amount to calculate a payment amount to a service provider indicated by each of the service provider identifiers.

This configuration charges each of the organization and the service provider for fee, so that an administrator of the server device can receive a management fee. The amount billed to the organization is calculated by adding a total amount of subsidy and a total of the management fee. The amount to be paid by the service provider is calculated by subtracting the management fee from the total amount of subsidy. This eliminates the need for the organization and the service provider to perform subsidy-related processing for each user.

In the support system described above, it is preferable that: the server device further includes an informing means configured to inform, of the amount of subsidy for each of the user identifiers, an organization indicated in the organization identifier stored in correlation with each of the user identifiers in the second storage means, and a settlement means configured to calculate a billing amount that is an organization handling charge in accordance with each of the organization list price total amounts and is an amount to be billed to an organization indicated by each of the organization identifiers, and calculate a billing amount that is a provider handling charge in accordance with each of the provider list price total amounts and is an amount to be billed to a service provider indicated by each of the service provider identifiers.

According to this configuration, the amount of subsidy for each user is informed to the organization, which enables each organization to find the amount of subsidy for each user.

In the support system described above, it is preferable that: the subsidy calculation information is a rate; and the second transmission means calculate the rate of the service amount as the amount of subsidy.

According to this configuration, the rate is used to calculate the amount of subsidy. This enables a constant rate to be used as the amount of subsidy independently of the service amount.

In the support system described above, it is preferable that the subsidy calculation information is a predetermined amount; and the second transmission means calculate the predetermined amount of the service amount as the amount of subsidy.

According to this configuration, since an amount preset as the amount of subsidy is given, the amount of subsidy is a constant amount independent of whether or not the service amount is large amount.

In the support system described above, it is preferable that the service provider is a restaurant, and providing the predetermined service is to provide food and drink.

This configuration enables the user to have a subsidized meal in a restaurant.

In the support system described above, it is preferable that the user has a terminal with a display unit for displaying an image showing the user identifier, and the obtaining means take a photograph of the image and obtains the user identifier from the photographed image.

In the support system described above, it is preferable that the server device further stores data for displaying the image showing the user identifier, and the terminal obtains the image from the server device and displays the image.

In the support system described above, it is preferable that the user has a printed matter on which an image showing the user identifier is printed, and the obtaining means take a photograph of the image and obtains the user identifier from the photographed image.

In the support system described above, it is preferable that the image is a barcode containing encoded information including the user identifier, and the obtaining means decode the barcode to obtain the user identifier.

In the support system described above, it is preferable that the user has a wireless tag for storing the user identifier, and the obtaining means read out the user identifier stored in the wireless tag.

In the support system described above, it is preferable that the user has a magnetic medium for storing the user identifier, and the obtaining means read out the user identifier stored in the magnetic medium.

The configuration enables the user to receive subsidy simply by presenting a portable item or the like.

In the support system described above, it is preferable that the obtaining means obtain, as the user identifier, biometrics information of the user from the user.

The configuration enables the user to receive subsidy simply by presenting his/her biometrics information.

A support system according to one aspect of the present invention is a support system including a user terminal and a server device configured to perform communication with the user terminal. The user terminal includes: an obtaining means configured to obtain a user identifier for identifying a user, an imaging means configured to obtain an image of a receipt in which a service amount that is a price of a predetermined item or service provided to the user and a time are indicated, and a first transmission means configured to send the image obtained by the imaging means and the user identifier to the server device. The server device includes a first storage means configured to store the user identifier, an organization identifier for identifying an organization to which the user indicated in the user identifier belongs, and subsidy calculation information in correlation with one another in advance; a subsidy calculation means configured to receive the image and the user identifier from the user terminal, extract the service amount from the received image, and calculate an amount of subsidy by using the extracted service amount and the subsidy calculation information stored in correlation with the received user identifier in the first storage means; a second storage means configured to store the user identifier received from the user terminal in correlation with the amount of subsidy, and an informing means configured to inform, of the amount of subsidy for each of the user identifiers, an organization indicated in the organization identifier stored in correlation with each of the user identifiers in the first storage means.

The support system having such a configuration enables the user to receive the amount of subsidy when he/she takes an image of a receipt to send the image to the server device. For example, as long as the user sends the image of the receipt appropriately, the amount of subsidy are summed up every month and the organization makes a payment to the user.

The imaging means obtains, as the image of the receipt, an image further showing a time. The support system is provided with a subsidy determination means configured to receive the image and the user identifier from the user terminal, extract the service amount and the time from the received image, and determine whether to subsidize the predetermined item or service based on the extracted time. The subsidy calculation means calculate the amount of subsidy when the subsidy determination means determine the predetermined item or service to be subsidized.

This configuration makes it possible to limit a period during which to use employee benefits service to be subsidized in a company and so on to an intended period. Stated differently, this configuration makes it possible to provide an employee benefits service with few unfair situations between staff members as compared to conventional technologies.

A computer program according to one embodiment of the present invention is a computer program that causes a computer to function as any one of the server devices. A recording medium according to one embodiment of the present invention is a readable recording medium on which the computer program is recorded.

### ADVANTAGEOUS EFFECTS OF INVENTION

The support system according to the present invention enables a company to offer convenient employee benefits services to staff and so on. For example, even if a company cafeteria is not installed actually, employee benefits services equivalent to that for a case where a company cafeteria is installed can be offered to employees.

### BRIEF DESCRIPTION OF DRAWINGS

FIG. 1 is a diagram showing an example of the configuration of a support system according to a first embodiment.

FIG. 2 is a functional block diagram of a support system according to the first embodiment.

FIG. 3 is a diagram showing an example of the structure and content of a subsidy calculation information table.

FIG. 4 is a diagram showing an example of the structure and content of a time information table.

FIG. 5 is a diagram showing an example of the structure and content of a management fee information table.

FIG. 6 is a diagram showing an example of the structure and content of a registered company information table.

FIG. 7 is a diagram showing an example of the structure and content of a registered shop information table.

FIG. 8 is a diagram showing an example of the structure and content of a subsidy historical information table.

FIG. 9 is a diagram showing an example of the structure and content of a member information table.

FIG. 10 is a diagram showing an example of the structure and content of an employee information table.

FIG. 11 is a diagram showing an example of the structure and content of a subsidy information table.

FIG. 12 is a flowchart depicting shop use processing.

FIG. 13 is a flowchart depicting subsidy determination processing.

FIG. 14 is a flowchart depicting subsidy calculation processing.

FIG. 15 is a flowchart depicting settlement processing.

FIG. 16 shows, in (a), an example of an employee login screen and, in (b), an example of an employee identification screen.

FIG. 17 is a diagram showing an example of a shop login screen.

FIG. 18 shows, in (a), an example of a shop amount entry screen and, in (b), an example of a shop checkout screen.

FIG. 19 is a functional block diagram of a support system according to a second embodiment.

FIG. 20 is a flowchart depicting shop use processing according to the second embodiment.

FIG. 21 is a flowchart depicting settlement processing according to the second embodiment.

FIG. 22 is a diagram showing an example of a shop checkout screen according to the second embodiment.

FIG. 23 is a diagram showing an example of the configuration of a support system according to a third embodiment.

FIG. 24 is a functional block diagram of a support system according to the third embodiment.

FIG. 25 is a flowchart depicting report processing according to the third embodiment.

FIG. 26 is a flowchart depicting settlement processing according to the third embodiment.

FIG. 27 is a diagram showing an example of a report confirmation screen according to the third embodiment.

### DESCRIPTION OF EMBODIMENTS

### First Embodiment

In the first embodiment, the description provides an example of the case where employees (workers) of a company use restaurants in a town as if they used a company cafeteria of their company.

In the embodiments, the description provides an example of the use of a food-related employee benefits service, namely, of the use of restaurants. The present invention is also applicable to shops related to other employee benefits services such as a gymnasium, hospital, and accommodation facility. The present invention is also applicable to shops where items are sold, for example, to supermarkets and convenience stores where items are sold. The present invention is also applicable to vending machines where items are sold. In the embodiments, the description provides an example of an employee benefits service offered by a company to employees. What offers employee benefits service is not limited to a company, may be any organization (group) including a plurality of persons, may be a profit-making organization or non-profit organization, and may or may not have a corporate status. The present invention is applicable to a case where the organization offers predetermined service to members of the organization. The organization is not only a company but also may be a union, local public organization, foundation, or school corporation. Alternatively, the organization may be an organization that issues or manages a predetermined point card. In such a case, a point card holder corresponds to a member of the organization.

Hereinafter, one embodiment of the present invention is described in accordance with drawings.

### Configuration

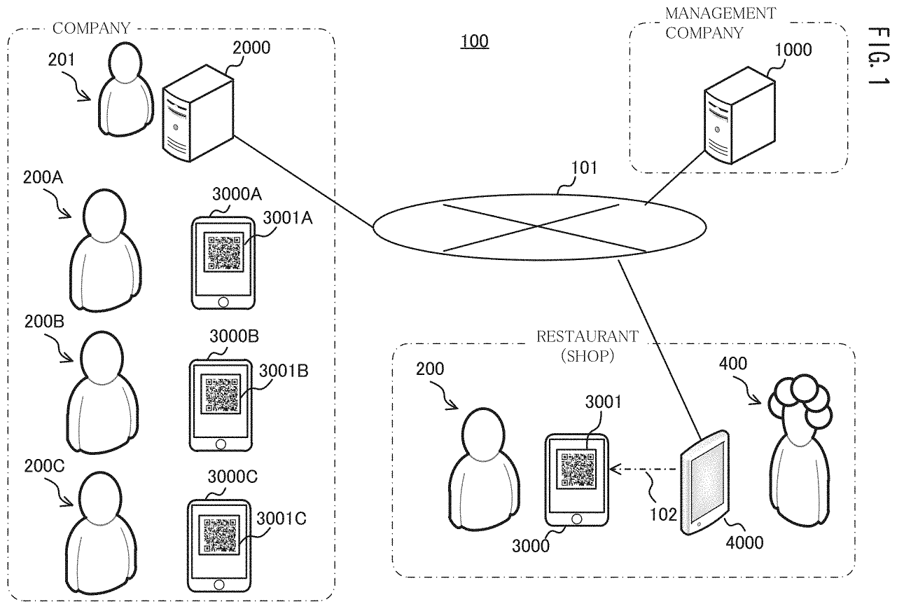

FIG. 1 is a diagram showing an example of the configuration of a support system 100. The support system 100 is configured of a management server device 1000, a company server device 2000, an employee terminal 3000, a shop terminal 4000, and so on.

The company server device 2000 and the shop terminal 4000 are connected to the management server device 1000 via a network 101 that is a wide-area network such as a network provided by a telecommunications carrier or the Internet. A dot-dash line 102 shows image capturing.

The management server device 1000 is managed by a management company that operates the support system 100. The management server device 1000 is a so-called server for supporting (assisting) employee benefits of a company.

The company server device 2000 is a processing device such as a personal computer owned by a company (organization) registered in the support system 100. Such a company is hereinafter referred to as a “registered company”.

An employee terminal 3000A, an employee terminal 30006, and an employee terminal 3000C are terminals that are carried respectively by an employee (user) 200A, an employee 200B, and an employee 200C who work in the registered company. In the embodiment, it is assumed that the terminals are smartphones. Barcode images 3001A, B, and C are displayed in screens of the employee terminals 3000A, B, and C, respectively. The barcode images 3001A, B, and C are two-dimensional barcode images containing encoded information such as employee identifiers (IDs) of the employees 200A, B, and C. Hereinafter, the employees 200A, B, and C are collectively referred to as an employee 200, the employee terminals 3000A, B, and C are collectively referred to as the employee terminal 3000, and the barcode images 3001A, B, and C are collectively referred to as a barcode image 3001. In FIG. 1, for the purpose of illustration, three of the employees 200A, B, and C are exemplified as the employee 200; however, the number of employees 200 is not limited to three.

A company server administrator 201 manages the company server device 2000. The company server administrator 201 performs processes such as registering the employee 200 at the management server device 1000 so that the employee 200 can use the support system 100.

The shop terminal 4000 is installed in a restaurant (service provider) registered in the support system 100 (hereinafter, referred to as a “registered shop”). The shop terminal 4000 is a processing device such as a personal computer used by a restaurant worker 400. It is assumed that the shop terminal 4000 is a smartphone in this embodiment.

### Example of Use

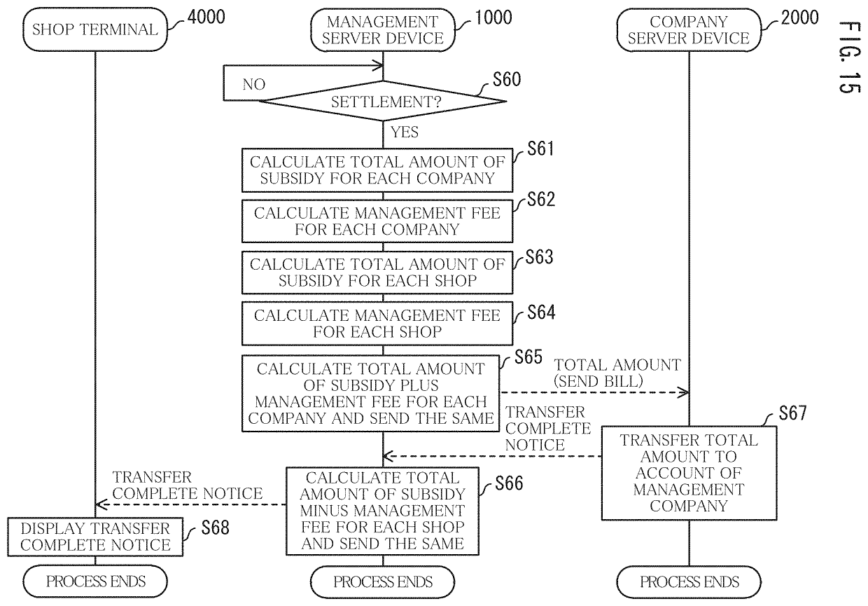

The description goes on to an example of use of the support system 100 by using FIG. 1 with reference to FIGS. 15-17. It is supposed that an employee 200 of a registered company has lunch at one of registered shops.

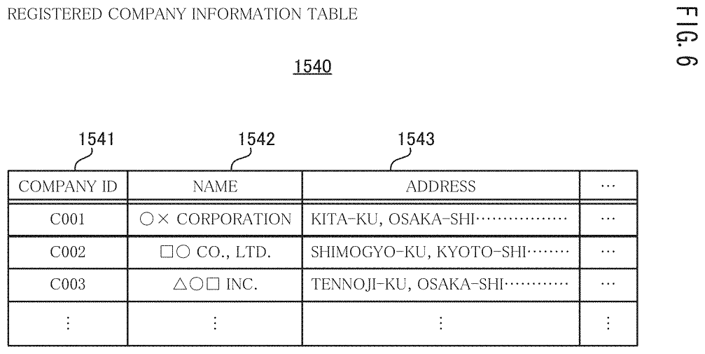

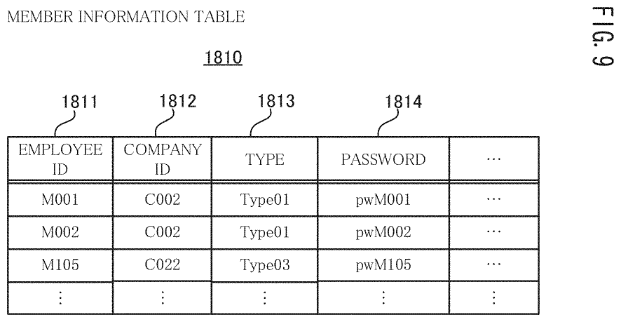

It is assumed that the employee 200 is registered in advance at the management server device 1000 of the support system 100. The company server administrator 201 performs processes for registering his/her company at the management server device 1000 and registering necessary information such as an employee ID of the employee 200 at the management server device 1000. The company server administrator 201 performs the registration process on a website of the support system 100. Alternatively, the company server administrator 201 performs the registration process by applying for registration to the management company of the management server device 1000. After the registration process, the company is registered in a registered company information table 1540 (see FIG. 6) described later, and then, the employee 200 is registered in a member information table 1810 (see FIG. 9). Another configuration is possible in which, after the company is registered, each of the employees 200 may apply for registration on the website of the support system 100, and after the company server administrator 201 accepts the application in response to a notice from the management company, the employee 200 is registered in the member information table 1810.

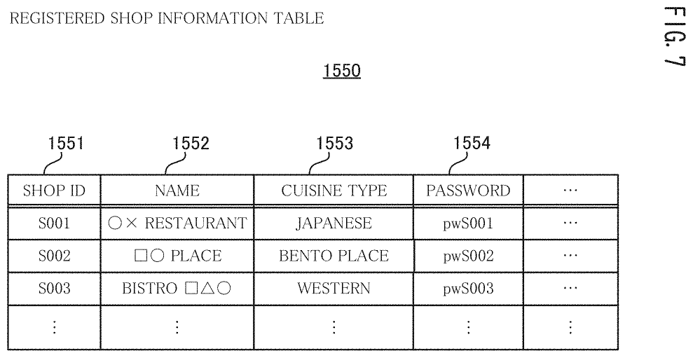

As with the company, a shop is also registered in the support system 100, for example, on the website. In response to the registration process, a shop is registered in a registered shop information table 1550 (see FIG. 7) described later.

After lunch, when paying a restaurant worker 400 for the price (equivalent value), the employee 200 makes a barcode image 3001 visible on a screen of an employee terminal 3000 carried by the employee 200 and shows the barcode image 3001 to the restaurant worker 400. To be specific, the employee 200 makes an employee login screen 3110 of the support system 100 visible.

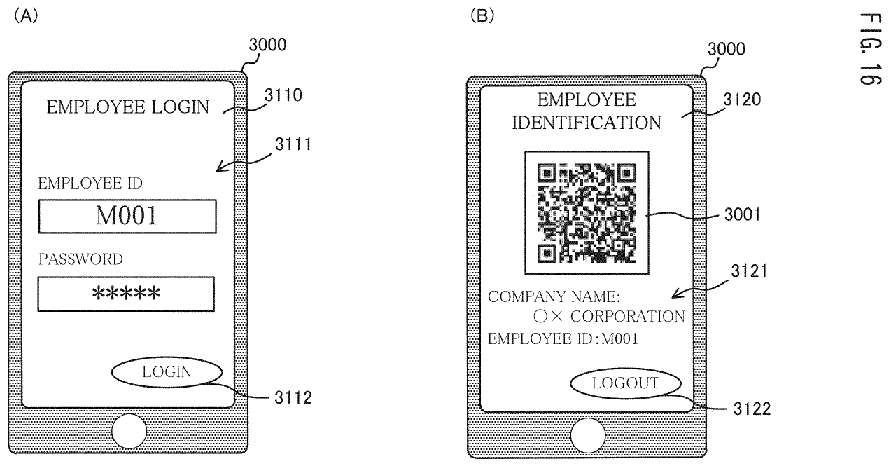

An example of the employee login screen 3110 is shown in (a) of FIG. 16. The employee login screen 3110 has an area into which login information 3111 is to be inputted. In this embodiment, an employee ID and a password are entered as the login information 3111. The employee 200 enters his/her employee ID and password to press a login button 3112.

After the login, an employee identification screen 3120 containing the barcode image 3001 is displayed in the employee terminal 3000. An example of the employee identification screen 3120 is shown in (b) of FIG. 16. The employee identification screen 3120 has the barcode image 3001 and employee information 3121. In this embodiment, the name of a company which the employee works in and his/her employee ID are displayed as the employee information 3121. In order to leave the employee identification screen 3120, the employee 200 presses a logout button 3122.

The restaurant worker 400 first logs into the support system 100. Specifically, the restaurant worker 400 displays a shop login screen 4110 on the website of the support system 100 to log thereinto.

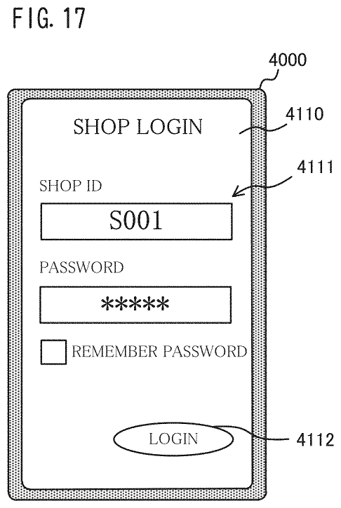

FIG. 17 shows an example of the shop login screen 4110. The shop login screen 4110 has an area into which login information 4111 is to be inputted. In this embodiment, a shop ID, a password, and a command to store the password are entered as the login information 4111. The restaurant worker 400 enters, as the login information 4111, a shop ID and a password, selects a remember password checkbox, and then presses the login button 4112. Note that, if the remember password checkbox is selected, afterward, the login processing is automatically performed in accessing the website.

When a camera of the shop terminal 4000 starts, the restaurant worker 400 photographs the barcode image 3001 on the employee identification screen 3120.

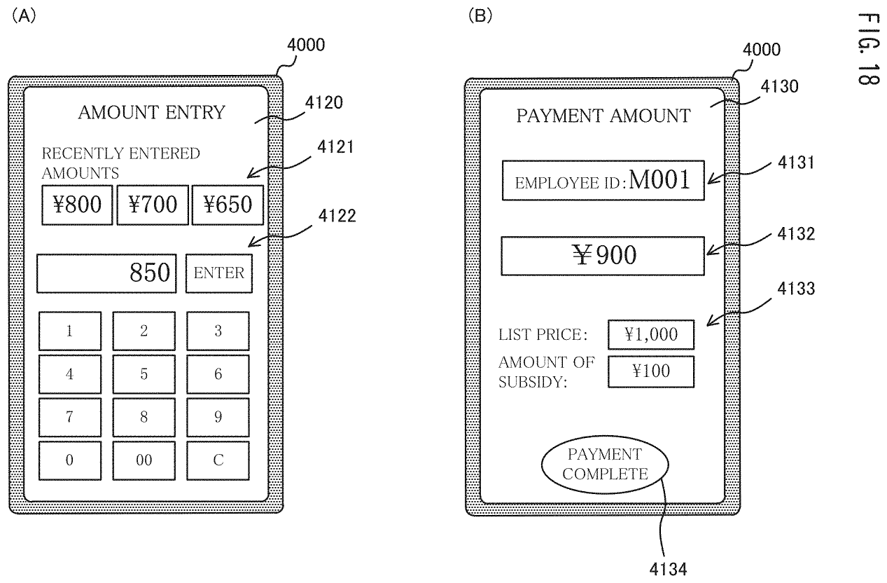

In response to the restaurant worker 400 photographing the barcode image 3001, a shop amount entry screen 4120 is displayed in the shop terminal 4000. FIG. 18 shows, in (a), an example of the shop amount entry screen 4120. The shop amount entry screen 4120 has an amount button list 4121 of buttons which show recently entered amounts and numeric keys 4122.

In a case where the corresponding food and drink expenses are shown in the amount button list 4121, the restaurant worker 400 presses a button showing the corresponding amount. In a case where no corresponding food and drink expenses are shown in the amount button list 4121, the restaurant worker 400 presses buttons of the numeric keys 4122 to input the amount, and then presses an “enter” button.

In response to the restaurant worker 400 entering the food and drink expenses, a shop checkout screen 4130 is displayed. FIG. 18 shows, in (b), an example of the shop checkout screen 4130.

The shop checkout screen 4130 has an employee ID 4131, a payment amount 4132, and subsidy information 4133. The employee ID of the employee 200 is displayed as the employee ID 4131. Food and drink expenses to be paid by the employee 200, in other words, expenses after subtraction of the amount of subsidy, is displayed as the payment amount 4132. The list price (expense) and the amount of subsidy are displayed as the subsidy information 4133. It is possible to provide, in the shop amount entry screen 4120, an area into which the name of a dish that the employee 200 has eaten is to be inputted. In a case where the restaurant worker 400 enters the dish name, the dish name is also displayed in the shop checkout screen 4130.

The employee 200 confirms that his/her employee ID is displayed in the shop checkout screen 4110, and pays the amount displayed as the payment amount 4112 to the restaurant worker 400. The restaurant worker 400 receives the payment and presses a payment complete button 4134.

As described above, the support system 100 enables the restaurant to provide lunch with almost the same effort as that in usual settlement processing, enables the employee to have lunch in an easy manner such as showing his/her ID, and enables the company to provide the employees 200 with lunch at a low price.

The restaurant worker 400 uses the shop amount entry screen 4120 to enter the price of the food and drink the employee 200 has eaten. Instead of this, however, the amount may be entered by using another method. For example, a menu showing a dish name and a price thereof in two-dimensional barcode may be created in advance, and the restaurant worker 400 may use the shop terminal 4000 to photograph a two-dimensional barcode of the corresponding dish name. In such a case, the shop terminal 4000 decodes the barcode to obtain the dish name and the price of the food and drink.

In using the support system 100, the employee 200 and the restaurant worker 400 access the website of the support system 100 from the individual terminals. Instead of this, however, an employee application and a shop application may be provided to the employee 200 and the restaurant worker 400, respectively. To be specific, when the employee 200 clicks on an icon of the employee application displayed in a display unit of the employee terminal 3000, the employee identification screen 3120 is displayed. When the restaurant worker 400 clicks on a shop icon displayed in a display unit of the shop terminal 4000, the shop amount entry screen 4120 is displayed.

### Configuration of Each Device

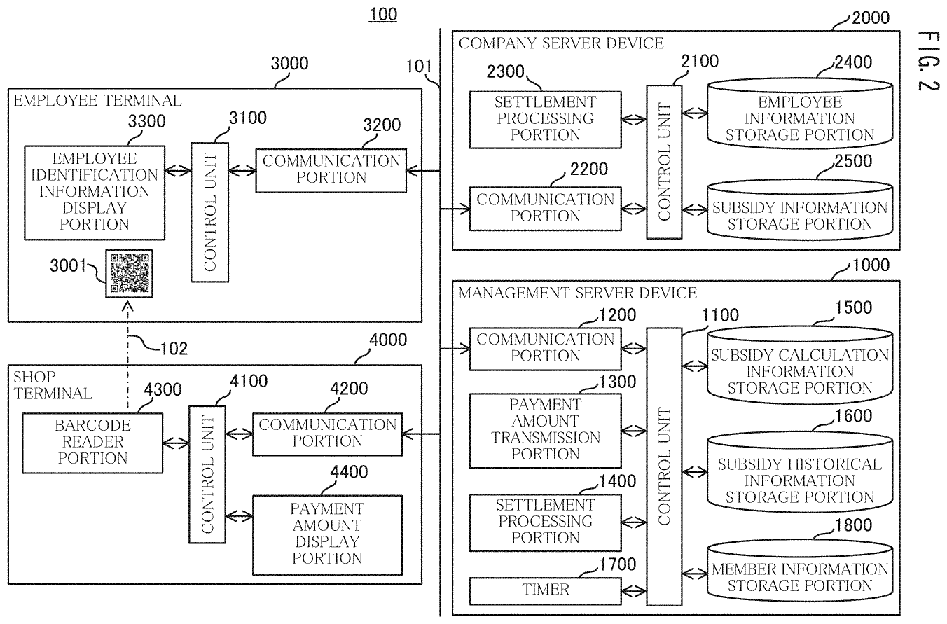

Next, the description goes on to the configuration of each of the devices of the support system 100 with reference to FIG. 2. FIG. 2 is a functional block diagram of the management server device 1000, the company server device 2000, the employee terminal 3000, and the shop terminal 4000.

Each of the employee terminal 3000 and the shop terminal 4000 is a mobile terminal (smartphone) and includes, as a human-machine interface, a touch panel that is a combination of a display device and an input device. The employee terminal 3000 and the shop terminal 4000 each has a web browser function for example. The employee terminal 3000 and the shop terminal 4000 each sends a Hyper Text Transfer Protocol (HTTP) request to the management server device 1000, and in response thereto, receives indicative data on a web page, for example, and displays each screen in the display unit. In contrast, the management server device 1000 has a so-called web server function. The management server device 1000 performs predetermined processing, for example, in response to a request from the shop terminal 4000, and sends the indicative data on a web page based on the processing result to the shop terminal 4000.

The employee terminal 3000 includes a control unit 3100, a communication portion 3200, and an employee identification information display portion 3300.

The control unit 3100 controls the other functional portions to perform processing for displaying the employee identification screen.

The communication portion 3200 performs communication with the management server device 1000 and so on via the network 101.

The employee identification information display portion 3300 has a function as a so-called browser and displays the barcode image 3001, for example, in the display unit.

The shop terminal 4000 includes a control unit 4100, a communication portion 4200, a barcode reader portion 4300, and a payment amount display portion 4400.

The control unit 4100 controls the other functional portions to perform processing for displaying the shop checkout screen.

The communication portion 4200 performs communication with the management server device 1000 and so on via the network 101.

The barcode reader portion 4300 includes a camera. The barcode reader portion 4300 photographs the barcode image 3001 to decode the barcode photographed.

The payment amount display portion 4400 has a so-called browser function. In response to a command from the restaurant worker 400, the payment amount display portion 4400 performs communication with the management server device 1000 via the communication portion 4200 to perform processing for displaying the shop checkout screen 4130, and so on.

The company server device 2000 includes a control unit 2100, a communication portion 2200, a settlement processing portion 2300, an employee information storage portion 2400, and a subsidy information storage portion 2500.

The control unit 2100 controls the other functional portions to perform processing for settling the amount of subsidy to be received by an employee, and so on.

The communication portion 2200 performs communication with the management server device 1000 and so on via the network 101.

When being informed of the monthly billing amount that is sent from the management server device 1000, the settlement processing portion 2300 performs processing for transferring money to an account of the management company of the support system 100. After the settlement processing portion 2300 finishes the transfer, the management server device 1000 is informed that the billing amount has been paid.

The employee information storage portion 2400 stores, therein, information on employees.

The subsidy information storage portion 2500 stores, therein, content of the employee benefits service, more specifically, information for calculating the amount of subsidy.

The management server device 1000 includes a control unit 1100, a communication portion 1200, a payment amount transmission portion 1300, a settlement processing portion 1400, a subsidy calculation information storage portion 1500, a subsidy historical information storage portion 1600, a timer 1700, and a member information storage portion 1800.

The control unit 1100 controls the other functional portions to perform control processing on the entire system and so on.

The communication portion 1200 performs communication with the employee terminal 3000, the shop terminal 4000, and the company server device 2000 via the network 101.

When data is received from the shop terminal 4000, the payment amount transmission portion 1300 calculates the amount of payment, and informs the shop terminal 4000 of the calculated payment amount. For example, the payment amount transmission portion 1300 generates data for displaying the shop checkout screen 4130 in which the payment amount is displayed and sends the data to the shop terminal 4000.

The settlement processing portion 1400 calculates, at a preset date, a billing amount to be billed to each of the registered companies and informs the billing amount to the company server device 2000 of each of the companies. The settlement processing portion 1400 also calculates, at a preset date, a billing amount to be billed to each of the registered shops and informs the billing amount to the shop terminal 4000 of each of the restaurants.

The subsidy calculation information storage portion 1500 stores, therein, information for calculating subsidy for each of the registered companies.

The subsidy historical information storage portion 1600 stores, therein, a usage history of each employee, i.e., the amount of subsidy reduced from the price of food and drink, and so on.

In response to a request from the control unit 1100, the timer 1700 detects the current time and date and informs the same to the control unit 1100.

The member information storage portion 1800 stores, therein, information on registered members, namely, employees of registered companies that are allowed to use the support system 100.

As described above, each of the management server device 1000, the company server device 2000, the employee terminal 3000, and the shop terminal 4000 is configured of a computer. Software programs stored in a storage (not shown) such as a hard disk drive of each of the management server device 1000, the company server device 2000, the employee terminal 3000, and the shop terminal 4000 are executed by a Central Processing Unit (CPU), so that the functional portions described above are implemented.

### Data

Next, the description goes on to major data used in the support system 100.

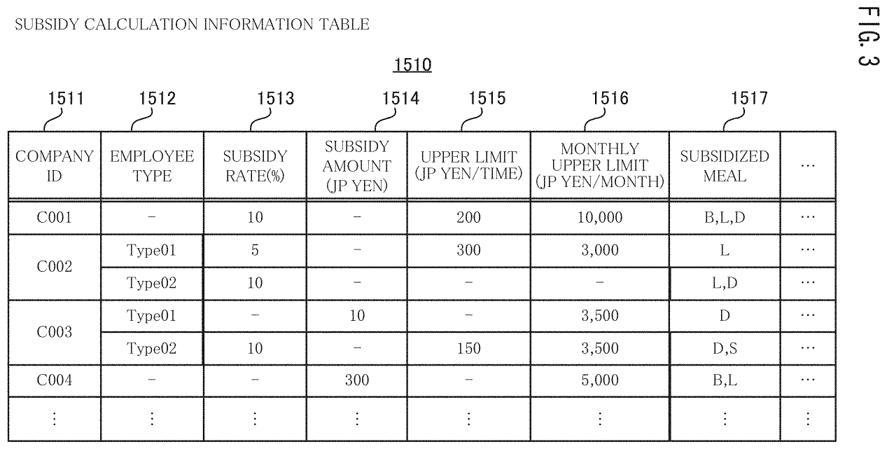

FIG. 3 is a diagram showing an example of the structure and content of a subsidy calculation information table 1510 stored in the subsidy calculation information storage portion 1500 of the management server device 1000. The subsidy calculation information table 1510 is a table in which information for calculating the amount of subsidy for each of the registered companies is stored. One record is registered for each employee type of each of the companies.

The subsidy calculation information table 1510 includes a company ID 1511, an employee type 1512, a subsidy rate 1513, a subsidy amount 1514, an upper limit 1515, a monthly upper limit 1516, and a subsidized meal 1517.

The company ID 1511 is an identifier for identifying a registered company (company ID).

The employee type 1512 indicates a category into which employees of a company identified by the company ID 1511 fall. For example, “Type 01” represents a full-time employee, “Type 02” represents a part-time employee, and so on. The employee type may be different for each company. It is only required that the employee type is an indicator for showing a difference in subsidy to be received by employees. Note that “-” represents no category, namely, represents that all employees fall into one category and receive the same subsidy as one another.

The subsidy rate 1513 indicates a rate (percentage) of subsidy. In a case where “10” is indicated therein for example, 10 percent of the food and drink expenses corresponds to the amount of subsidy. Note that “-” represents that no subsidy rate is set, namely, represents that the subsidy is not calculated by using the subsidy rate.

The subsidy amount 1514 indicates the amount of subsidy. In a case where “10” is indicated therein for example, 10 Japanese yen is subsidy irrespective of the food and drink expenses. Note that “-” represents that no subsidy is set, namely, represents that the amount of subsidy is not used as the subsidy amount 1514.

The subsidy rate 1513 or the subsidy amount 1514 is set for each employee type indicated in the employee type 1512.

The upper limit 1515 indicates an upper limit of subsidy per time for the case where the subsidy rate 1513 is used to calculate the subsidy. If the calculated subsidy exceeds the upper limit, then the upper limit is regarded as the subsidy. The upper limit 1515 is thus set only for a record having a value in the subsidy rate 1513. Note that “-” represents that no upper limit per time is set.

The monthly upper limit 1516 indicates an upper limit of the total amount of subsidy per month. Note that “-” represents that no upper limit per month is set. In this embodiment, it is supposed that the amounts of subsidy from 1^{st} to last day of every month are settled at once. Instead of the monthly upper limit, it is possible to use an upper limit for another period, for example, an annual upper limit.

The subsidized meal 1517 indicates a type of meal to be subsidized. To be specific, in the specification, “B” stands for breakfast, “L” stands for lunch, “D” stands for dinner, and “S” stands for late-night snack. Setting of “B, L” in the subsidized meal 1517 indicates that breakfast and lunch are subsidized.

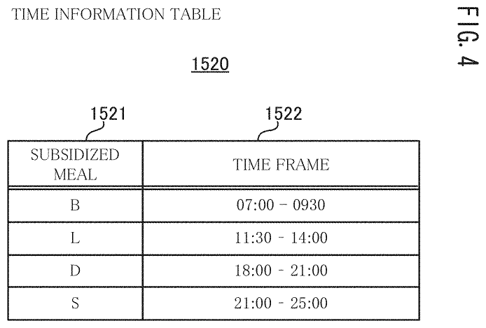

FIG. 4 is a diagram showing an example of the structure and content of a time information table 1520 stored in the subsidy calculation information storage portion 1500 of the management server device 1000. The time information table 1520 is a table in which time frames for determining a type of meal set as the subsidized meal 1517 of the subsidy calculation information table 1510 are stored. In the time information table 1520, one record is registered for one meal type.

The time information table 1520 includes a subsidized meal 1521 and a time frame 1522.

The subsidized meal 1521 indicates a meal type. The subsidized meal 1521 indicates a type of meal set as the subsidized meal 1517 of the subsidy calculation information table 1510. In this embodiment, the time information table 1520 has four records of “B”, “L”, “D”, and “S” set as the subsidized meal 1521.

The time frame 1522 indicates a time frame based on which a type of meal indicated as the subsidized meal 1521 is determined. In this embodiment, a meal type is determined based on a time at which an employee pays for a meal, namely, a time at which the management server device 1000 receives a request for calculation of a payment amount from the shop terminal 4000. For example, in a record having “B” in the subsidized meal 1521, “07:00-09:30” is shown in the time frame 1522. Thus, if a request for calculation of a payment amount is made by the shop terminal 4000 between 7:00 and 9:30, then it is determined that the request is one for breakfast.

In this embodiment, one time information table 1520 is stored for the support system 100. Instead of this, however, time information tables 1520 that are different among the registered companies in time frame may be stored.

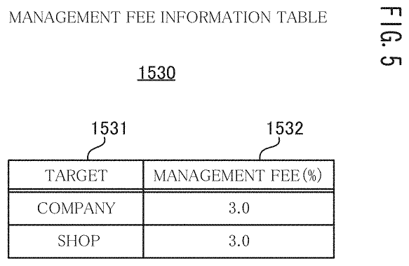

FIG. 5 is a diagram showing an example of the structure and content of a management fee information table 1530 stored in the subsidy calculation information storage portion 1500 of the management server device 1000. The management fee information table 1530 is a table with which an operating company of the support system 100 manages information for calculating handling charges to be billed to registered companies and registered shops.

The management fee information table 1530 includes a target 1531 and a management fee 1532.

The target 1531 indicates a target to which a handling charge is billed. In this embodiment, the target includes a “company” and a “shop” (restaurant).

The management fee 1532 indicates information for calculating a handling charge to be billed to a target indicated in the target 1531. In this embodiment, it is assumed that the management fee 1532 is an amount depending on the total amount of the food and drink expenses. For example, in a record indicating a “company” in the target 1531, a value of “3.0” is set as the management fee 1532. The handling charge is thus 3% of the total of the food and drink expenses (list price) covered by the subsidy.

In this embodiment, one management fee information table 1530 is stored for the support system 100. Instead of this, however, management fee information tables 1530 that are different among the registered companies in handling charge may be stored. Alternatively, for example, the management fee may be different for each branch, shop, or, region. Yet alternatively, the management fee may be a percentage to the amount of subsidy, instead of a percentage to the price of food and drink. The management fee may be a fixed amount rather than a percentage.

FIG. 6 is a diagram showing an example of the structure and content of the registered company information table 1540 stored in the subsidy calculation information storage portion 1500 of the management server device 1000. The registered company information table 1540 is a table in which information on companies registered in the support system 100 (registered companies) are stored.

The registered company information table 1540 includes a company ID 1541, a name 1542, and an address 1543.

The company ID 1541 indicates an identifier for identifying a registered company (company ID).

The name 1542 indicates the name of a company identified by an identifier of the company ID 1541.

The address 1543 indicates a location of the company identified by the identifier of the company ID 1541.

Aside from these items, it is supposed that the name of a responsible department within the company, the name of a person who is in charge, a department e-mail address, an address of the company server device 2000, and so on are stored.

FIG. 7 is a diagram showing an example of the structure and content of the registered shop information table 1550 stored in the subsidy calculation information storage portion 1500 of the management server device 1000. The registered shop information table 1550 is a table in which information on restaurants registered in the support system 100 (registered shops) is stored.

The registered shop information table 1550 includes a shop ID 1551, a name 1552, a cuisine type 1553, and a password 1554.

The shop ID 1551 indicates an identifier for identifying a registered shop (shop ID).

The name 1552 indicates the name of a restaurant identified by the identifier of the shop ID 1551.

The cuisine type 1553 indicates a type of cuisine served in a restaurant identified by an identifier of the shop ID 1551. The cuisine type is “Japanese food” and “French food”, for example.

The password 1554 shows a login password of a restaurant identified by an identifier of the shop ID 1551.

It is noted that the shop may be not only a shop serving food inside, but also be a shop such as a so-called bento place which provides to-go food. Other than those items above, it is supposed that the registered shop information table 1550 stores, as necessary, a person who is in charge, an email address of the person who is in charge, an address of the shop terminal 4000, and so on.

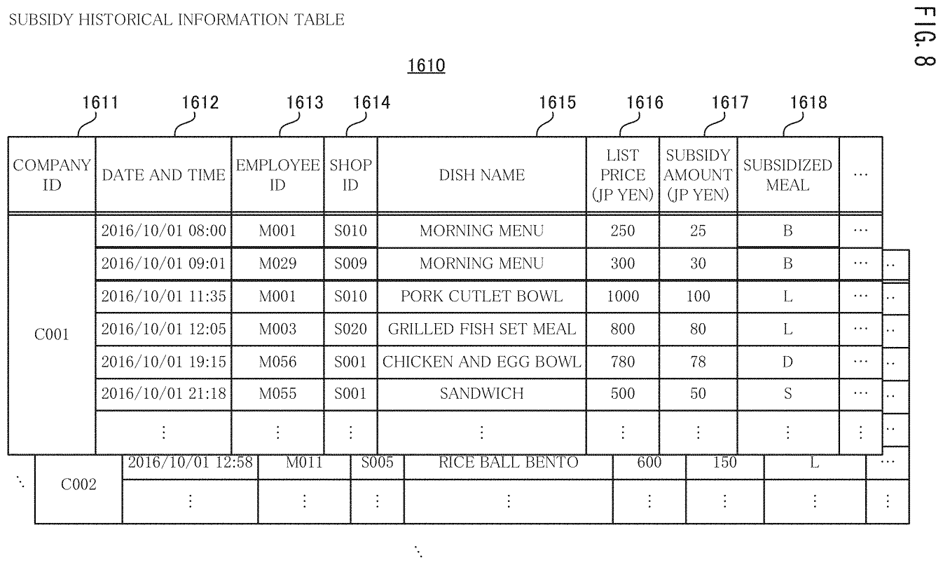

Next, FIG. 8 is a diagram showing an example of the structure and content of a subsidy historical information table 1610 stored in the subsidy historical information storage portion 1600 of the management server device 1000. The subsidy historical information table 1610 is a table in which a usage history showing that employees of registered companies use registered shops is stored. One table is created for one registered company. The subsidy historical information table 1610 is newly created every month, namely, is created after settlement.

The subsidy historical information table 1610 includes a company ID 1611, a date and time 1612, an employee ID 1613, a shop ID 1614, a dish name 1615, a list price 1616, a subsidy amount 1617, and a subsidized meal 1618.

The company ID 1611 indicates an identifier (company ID) for identifying a registered company.

The date and time 1612 indicates a date and time at which a registered shop has been used. In this embodiment, the date and time 1612 indicates a date and time at which the management server device 1000 has received a request for calculation of a payment amount from the shop terminal 4000.

The employee ID 1613 indicates an identifier for identifying an employee who works in a company identified by an identifier of the company ID 1611 (employee ID).

The shop ID 1614 indicates an identifier (shop ID) for identifying a registered shop that an employee identified by an identifier of the employee ID 1613 has used.

The dish name 1615 indicates the name of a dish that an employee identified by the identifier of the employee ID 1613 has had at a shop identified by the identifier of the shop ID 1614. The dish name 1615 is set for the case where the shop amount entry screen 4120 (see (a) of FIG. 18) has a region where a dish name is entered.

The list price 1616 indicates a list price of a dish corresponding to the dish name indicated in the dish name 1615.

The subsidy amount 1617 indicates the amount of subsidy for a list price indicated in the list price 1616 for the case where an employee, identified by the employee ID 1613, of a company, identified by the company ID 1611, has had a meal corresponding to a dish name indicated in the dish name 1615 at a date and time indicated in the date and time 1612 in a shop corresponding to the shop ID 1614.

The subsidized meal 1618 indicates a meal type corresponding to a dish name indicated in the dish name 1615. Any one of “B”, “L”, “D”, and “S” is set in this embodiment.

FIG. 9 is a diagram showing an example of the structure and content of the member information table 1810 stored in the member information storage portion 1800 of the management server device 1000. The member information table 1810 is a table in which information on employees (members) registered in the support system 100 is stored.

The member information table 1810 includes an employee ID 1811, a company ID 1812, a type 1813, and a password 1814.

The employee ID 1811 indicates an identifier for identifying a member (employee ID).

The company ID 1812 indicates a registered company in which an employee identified by an identifier of the employee ID 1811 works. Specifically, the company ID 1812 is a company ID.

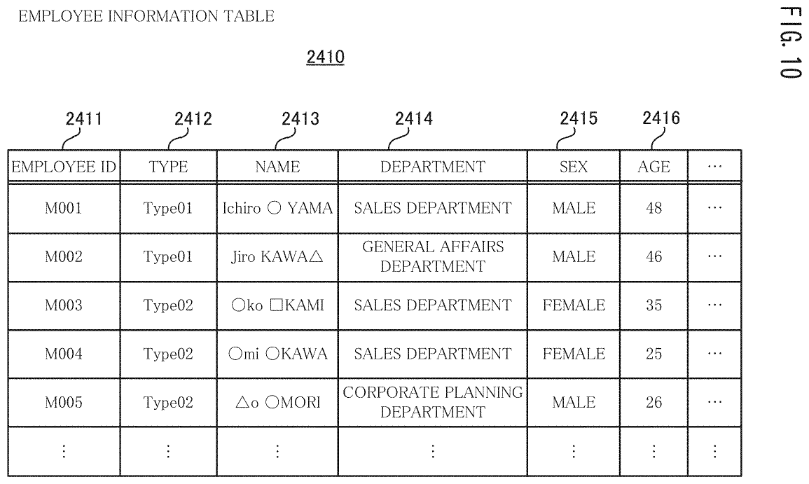

The type 1813 indicates a category into which an employee identified by an identifier of the employee ID 1811 falls. Stated differently, the type 1813 indicates a type of subsidy that the corresponding employee can receive. To be specific, in a record having an identifier indicated in the employee ID 1811 as an employee ID 2411 of an employee information table 2410 (see FIG. 10) of a registered company where the corresponding employee works in, what is indicated in the type 2412 is a type that is set as the type 1813.

The password 1814 indicates a login password of an employee identified by an identifier of the employee ID 1811.

FIG. 10 is a diagram showing an example of the structure and content of the employee information table 2410 stored in the employee information storage portion 2400 of the company server device 2000. The employee information table 2410 is a table with which a company registered in the support system 100 (registered company) manages information on employees who work in the subject company.

The employee information table 2410 includes an employee ID 2411, a type 2412, a name 2413, a department 2414, a sex 2415, and an age 2416.

The employee ID 2411 indicates an identifier for identifying an employee (employee ID).

The type 2412 indicates a category into which an employee identified by an identifier of the employee ID 2411 falls. For example, “Type 01” represents a full-time employee, “Type 02” represents a part-time employee, and so on. It is only necessary that the type functions as an indicator for determining a type of subsidy that the employee can receive.

The name 2413 indicates the name of an employee identified by an identifier of the employee ID 2411.

The department 2414 indicates a department in which an employee identified by the identifier of the employee ID 2411 works.

The sex 2415 indicates a sex of an employee identified by the identifier of the employee ID 2411.

The age 2416 indicates an age of an employee identified by the identifier of the employee ID 2411.

The employee ID 2411 and the type 2412 are essential items and personal information other than those may be stored as necessary.

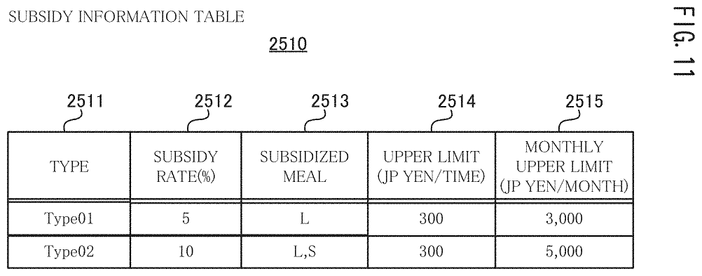

FIG. 11 is a diagram showing an example of the structure and content of a subsidy information table 2510 stored in the subsidy information storage portion 2500 of the company server device 2000. The subsidy information table 2510 is a table with which a company registered in the support system 100 (registered company) manages information on subsidy. The table shown in FIG. 10 is an example of a table for a company that uses a subsidy rate to calculate the amount of subsidy. In the case of using the amount of subsidy, a table in which the amount of subsidy is set is used. Where the subsidy information table 2510 is changed, the change is informed to the management server device 1000 so that the subsidy calculation information table 1510 is updated accordingly.

The subsidy information table 2510 includes a type 2511, a subsidy rate 2512, a subsidized meal 2513, an upper limit 2514, and a monthly upper limit 2515.

The type 2511 indicates a type of subsidy. To be specific, what is indicated in the type 2511 is a type that is set as the type 2412 of the employee information table 2410.

The subsidy rate 2512 indicates a rate (percentage) of subsidy.

The subsidized meal 2513 indicates a type of meal to be subsidized.

The upper limit 2514 indicates an upper limit of the subsidy amount per time.

The monthly upper limit 2515 indicates an upper limit of the total amount of subsidy per month.

### Operation

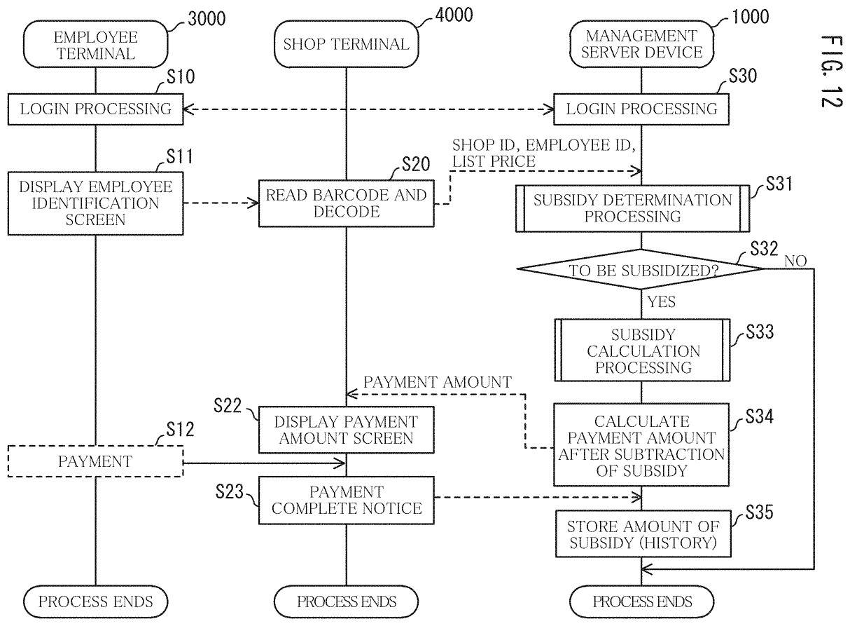

Next, the description goes on to processing performed in the support system 100 with reference to FIGS. 12-14.

### Payment Processing

First, the description goes on to payment processing for the case where an employee pays for a meal in a restaurant with reference to FIG. 12. FIG. 12 is a flowchart depicting the payment processing. In FIG. 12, an arrow indicated by a broken line shows the flow of data and processing indicated by a broken line rectangle shows processing performed by human.

An employee 200 of a registered company has a meal in a restaurant that is a registered shop. In paying the restaurant worker 400 for food and drink, the employee 2000 makes the employee identification screen 3110 (see FIG. 16) visible in the display unit of the employee terminal 3000 carried by him/her, and then shows the employee identification screen 3110 to the restaurant worker 400 (Step S10).

To be specific, the employee 200 performs, on the employee terminal 3000 carried by him/her, operation for displaying the employee identification screen 3110. The employee 200 accesses the website of the support system 100 (management server device 1000) through the employee identification information display portion 3300, makes the employee login screen 3110 (see (a) of FIG. 16) visible, enters his/her employee ID and password as the login information 3111, and presses the login button 3112. The employee identification information display portion 3300 sends the login information 3111 thus entered to the management server device 1000.

The management server device 1000 receives the login information 3111. The control unit 1100 generates indicative data for displaying the employee identification screen 3120 with reference to the member information table 1810 stored in the member information storage portion 1800. In particular, the control unit 1100 first generates a barcode image 3001 in a case where the received password is indicated as the password 1814 in a record having the received employee ID in the employee ID 1811. Where a server address (address of an application for performing payment processing in the management server device 1000) is “http://shashokusystem.com/discount/index”, and where a character string obtained by encrypting information on employee ID and so on is encrypted is “9da6ff4bc8c5abaa6b349a49eef153ac”, the control unit 1100 encodes “http://shashokusystem.com/discount/index?key=9da6ff4bc8c5abaa6 b349a49eef153ac” to generate a barcode image 3001. The control unit 1100 then reads out a company name with reference to the registered company information table 1540 (see FIG. 6) and generates indicative data for displaying the employee identification screen 3120. The control unit 1100 then sends the generated indicative data to the employee terminal 3000.

The employee terminal 3000 receives the indicative data on the employee identification screen 3120. The employee identification information display portion 3300 displays the employee identification screen 3120.

The restaurant worker 400 to whom the employee identification screen 3110 is shown uses the shop terminal 4000 to access the website of the support system 100 and performs login operation. It is supposed that, when the restaurant worker 400 logs in through the shop login screen 4110, a remember password checkbox is selected and the login information is stored in the browser (employee identification information display portion 3300).

The control unit 4100 detects the login operation and requests the payment amount display portion 4400 to calculate the payment amount. The payment amount display portion 4400 receives the request, obtains data necessary to calculate the payment amount, and sends the obtained data to the management server device 1000 (Step S20).

To be specific, the payment amount display portion 4400 receives the request and gives a command to read the barcode to the barcode reader portion 4300. The barcode reader portion 4300 receives the command and starts the camera. The restaurant worker 400 photographs the barcode image 3001 displayed in the employee identification screen 3120. After photographing the barcode image 3001, the barcode reader portion 4300 decodes the photographed image to convey the server address, the employee ID, and so on to the payment amount display portion 4400.

The payment amount display portion 4400 receives the server address, the employee ID from the barcode reader portion 4300, and so on to display the shop amount entry screen 4120 (see (a) of FIG. 18). The restaurant worker 400 enters the amount and presses an “enter” button. The payment amount display portion 4400 is informed of the amount, and conveys the amount (list price) thus received, the employee ID, the login information (shop ID, password), and so on to the server address, namely, to the management server device 1000.

The management server device 1000 receives the data from the shop terminal 4000. The control unit 1100 conveys, to the payment amount transmission portion 1300, the data thus received (hereinafter, the list price, the shop ID, and the employee ID are referred to as “target list price”, “target shop ID”, and “target employee ID”, respectively), and requests the payment amount transmission portion 1300 to calculate the payment amount. The payment amount transmission portion 1300 receives the request. The payment amount transmission portion 1300 first determines (Step S31) whether a meal corresponding to the received data (hereinafter, referred to as a “target meal”) is to be subsidized with reference to the data stored in the subsidy calculation information storage portion 1500.

If determining that the target meal is to be subsidized (Step S32: YES), then the payment amount transmission portion 1300 calculates the amount of subsidy for the target meal with reference to the data stored in the subsidy calculation information storage portion 1500 (Step S33).

The payment amount transmission portion 1300 then subtracts the amount of subsidy from the target list price to calculate the payment amount. The payment amount transmission portion 1300 generates indicative data for displaying the shop checkout screen 4130 in which the calculated payment amount, the target list price, and the calculated amount of subsidy are displayed, and sends the indicative data thus generated to the shop terminal 4000 of the restaurant identified by the target shop ID.

The payment amount display portion 4400 of the shop terminal 4000 receives the indicative data from the management server device 1000, and then displays the shop checkout screen 4130 in which the payment amount is displayed (see (b) of FIG. 18) (Step S22).

The restaurant worker 400 shows the shop checkout screen 4130 to the employee 200, receives the payment from the employee 200 (Step S12), and presses the payment complete button 4134 on the shop checkout screen 4110.

The control unit 4100 detects the payment complete button 4114 pressed, and informs the management server device 1000 that the payment has been completed (Step S23).

After being informed that the payment has been completed, the payment amount transmission portion 1300 of the management server device 1000 generates a record based on the data on target meal, adds the generated record to the subsidy historical information table 1610 (see FIG. 8) (Step S35), and finishes the processing. To be specific, the payment amount transmission portion 1300 sets, as the company ID 1611, a company ID indicated as the company ID 1812 in the record having the target employee ID in the employee ID 1811 of the member information table 1810. The payment amount transmission portion 1300 also sets, as the date and time 1612, a date and time at which the data on target meal has been received from the shop terminal 4000, and sets the target employee ID as the employee ID 1613. The payment amount transmission portion 1300 also sets a target shop ID as the shop ID 1614, sets a target list price as the list price 1616, and sets the amount of subsidy calculated in the processing of Step S32 as the subsidy amount 1617. The payment amount transmission portion 1300 also sets, as the subsidized meal 1618, a meal type determined in the processing of Step S31 to create a record, and adds the record to the subsidy historical information table 1610.

In Step S31, if determining that the target meal is not to be subsidized (Step S32: NO), then the payment amount transmission portion 1300 informs the shop terminal 4000 of the truth, and finishes the processing.

### Subsidy determination Processing

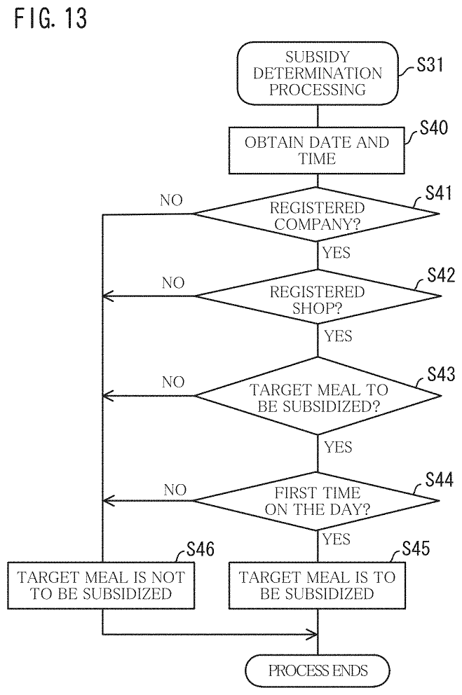

Next, the subsidy determination processing, which is the processing in Step S31 of FIG. 12, is described with reference to FIG. 13. FIG. 13 is a flowchart depicting the subsidy determination processing.

The payment amount transmission portion 1300 first asks the timer 1700 about the time and obtains the current date and time (Step S40).

The payment amount transmission portion 1300 then determines whether a company identified by the company ID (hereinafter, referred to as a “target company ID”) indicated in the company ID 1812 of the record that shows the target employee ID in the employee ID 1811 of the member information table 1810 is a company registered in the support system 100 (Step S41).

To be specific, the payment amount transmission portion 1300 searches for a record that has the target company ID in the company ID 1541 of the registered company information table 1540 (see FIG. 6). If the record is found out by the search, then the payment amount transmission portion 1300 determines that the company is a company registered in the support system 100 (Step S41: YES). In contrast, if the record is not found out by the search, then the payment amount transmission portion 1300 determines that the target company ID is one for a company not registered in the support system 100 (Step S41: NO). The payment amount transmission portion 1300 then determines that the target meal is not to be subsidized, and finishes the processing (Step S46).

The payment amount transmission portion 1300 determines that the target company ID is a registered company (Step S41: YES), and then, determines whether the restaurant identified by the target shop ID is a restaurant registered in the support system 100 (Step S42).

To be specific, the payment amount transmission portion 1300 searches for a record that has the target shop ID in the shop ID 1551 of the registered shop information table 1550 (see FIG. 7). If the record is found out by the search, then the payment amount transmission portion 1300 determines that the restaurant is a restaurant registered in the support system 100 (Step S42: YES). In contrast, if the record is not found out by the search, then the payment amount transmission portion 1300 determines that the target shop ID is one for a restaurant not registered in the support system 100 (Step S42: NO). The payment amount transmission portion 1300 then determines that the target meal is not to be subsidized, and finishes the processing (Step S46).

The payment amount transmission portion 1300 determines that the target shop ID is a registered shop (Step S42: YES), and then, determines whether the current time is included in a time frame for subsidy, namely, whether the target meal is to be subsidized (Step S43).

To be specific, the payment amount transmission portion 1300 searches for a record having the current time in the time frame indicated in the time frame 1522 of the time information table 1520 (see FIG. 4). If the record is found out by the search, then the payment amount transmission portion 1300 reads out a meal type indicated as the subsidized meal 1521 of the record, for example, reads out “L”. If the type thus read out (hereinafter, referred to as a “target type”) is indicated as the subsidized meal 1517 of the record that has the target company ID in the company ID 1511 of the subsidy calculation information table 1510 (see FIG. 3), then the payment amount transmission portion 1300 determines that the current time is included in a time frame for subsidy (Step S43: YES). In contrast, if the target type is not indicated as the subsidized meal 1517, then the payment amount transmission portion 1300 determines that the current time is not included in a time frame for subsidy (Step S43: NO), determines that the target meal is not to be subsidized, and finishes the processing (Step S46).

The payment amount transmission portion 1300 determines that the current time is included in a time frame for subsidy (Step S43: YES). The payment amount transmission portion 1300 then determines whether the current time is the first within the time frame for subsidy, namely, determines whether the target meal is the first meal of the target type (Step S44). For example, the reason therefor is that, when an employee of a registered company, for whom one lunch per day is supposed to be subsidized, has lunch twice a day, only the first lunch is subsidized. In this embodiment, as for meals of the same type, only the first meal per day is subsidized; however, a plurality of times of meal per day may be subsidized.

To be specific, the payment amount transmission portion 1300 searches the subsidy historical information table 1610 (see FIG. 8) for a record that has the target company ID in the company ID 1611, has the target employee ID in the employee ID 1613, has the current date in the date and time 1612, and has the target type in the subsidized meal 1618 (see FIG. 8). If the record is not found out by the search, then the payment amount transmission portion 1300 determines that the target meal is the first meal (Step S44: YES), and that the target meal is to be subsidized, and finishes the processing (Step S45). In contrast, if the record is found out by the search, then the payment amount transmission portion 1300 determines that the target meal is not the first meal (Step S44: NO), and that the target meal is not to be subsidized, and finishes the processing (Step S46).

### Subsidy Calculation Processing

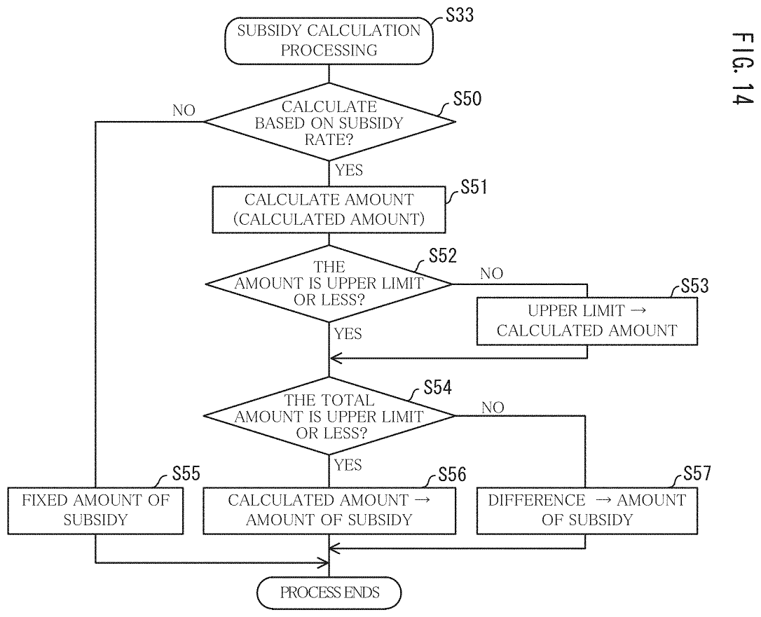

The description goes on, with reference to FIG. 14, to the subsidy calculation processing that is the processing in Step S33 of FIG. 12. FIG. 14 is a flowchart depicting the subsidy calculation processing.

The payment amount transmission portion 1300 determines whether the amount of subsidy for the target meal is to be calculated based on the subsidy rate or is to be set to a fixed amount of subsidy (Step S50). To be specific, the payment amount transmission portion 1300 reads out, from the subsidy calculation information table 1510 (see FIG. 3), a record having the target company ID in the company ID 1511 and the target employee type in the employee type 1512. The payment amount transmission portion 1300 determines that subsidy for the target meal is set to a fixed subsidy rate in a case where the record thus read out has a value of “-” in the subsidy rate 1513. For the other cases, the payment amount transmission portion 1300 determines that subsidy for the target meal is to be calculated based on the subsidy rate.

If determining that the amount of subsidy for the target meal is to be set to a fixed amount of subsidy (Step S50: NO), then the payment amount transmission portion 1300 determines that the amount set in the subsidy amount 1514 of the read record is used as the amount of subsidy (Step S55) and finishes the processing.

If determining that subsidy for the target meal is to be calculated based on the subsidy rate (Step S51: Yes), then the payment amount transmission portion 1300 multiplies the target list price by the subsidy rate that is set as the subsidy rate 1513, and determines the amount of money (hereinafter, referred to as a “calculated amount”) (Step S51). For example, supposing that the target list price is “1000 yen” and the subsidy rate is “10%”, the calculated amount is 100 yen through the calculation of 1000×0.10.

The payment amount transmission portion 1300, which has determined the calculated amount, determines whether the calculated amount is equal to or less than the upper limit per meal (Step S52). To be specific, the payment amount transmission portion 1300 reads out the upper limit indicated as the upper limit 1515 in the record read out. If the calculated amount is more than the upper limit thus read out (Step S52: NNo), then the payment amount transmission portion 1300 uses the calculated amount as the upper limit (Step S53).

Next, where the calculated amount is used as the amount of subsidy, the payment amount transmission portion 1300 determines whether the total amount of subsidy this month is equal to or less than the upper limit per month (Step S54). To be specific, the payment amount transmission portion 1300 reads out the upper limit per month indicated in the monthly upper limit 1516 of the record thus read out. The payment amount transmission portion 1300 then reads out, from the subsidy historical information table 1610 (see FIG. 8) for this month, a record in which the target company ID is indicated in the company ID 1611 and the target employee ID is indicated in the employee ID 1613. The payment amount transmission portion 1300 then adds the amounts indicated as the subsidy amount 1617 to the record thus read out, and calculates the total amount. If the amount obtained by adding the calculated amount to the total amount is equal to or less than the upper limit per month (Step S54: YES), then the payment amount transmission portion 1300 uses the calculated amount as the amount of subsidy (Step S55) and finishes the processing. In contrast, if the amount obtained by adding the calculated amount to the total amount is more than the upper limit per month (Step S54: NO), then the payment amount transmission portion 1300 uses, as the amount of subsidy, the amount calculated by subtracting the total amount from the upper limit per month (Step S56) and finishes the processing.

### Settlement Processing

The description goes on to the settlement processing with reference to FIG. 15. FIG. 15 is a flowchart depicting the settlement processing. In FIG. 15, an arrow indicated by a broken line shows the flow of data.

In the management server device 1000, the control unit 1100 detects (Step S60: YES) the start of settlement in response to interruption from the timer 1700, and makes a request for settlement processing to the settlement processing portion 1400. It is supposed that the timer 1700 has been so set as to interrupt the control unit 1100 at the date and time of the settlement. Instead of this, it is also possible that the administrator of the support system 100 instructs the control unit 1100 to make a command to start the settlement processing.

The settlement processing portion 1400 receives the command to start the settlement, refers to the subsidy historical information table 1610 (see FIG. 8), and calculates the total amount of subsidy for each registered company (Step S61). To be specific, for each of the company IDs indicated in the company ID 1611 of the registered company information table 1540 (see FIG. 6), the settlement processing portion 1400 reads out a record having the company ID in the company ID 1611 from the subsidy historical information table 1610. The settlement processing portion 1400 then adds the amount indicated in the subsidy amount 1617 of each of the records thus read out, and then calculates the total amount of subsidy.

The settlement processing portion 1400, which has calculated the total amount of subsidy for each of the registered companies, calculates a management fee for each registered company (Step S62). To be specific, the settlement processing portion 1400 reads out a fee rate indicated in the management fee 1532 of the record having “company” in the target 1531 of the management fee information table 1530 (see FIG. 5). For each of the company IDs indicated in the company ID 1611 of the registered company information table 1540, the settlement processing portion 1400 reads out a record having the company ID in the company ID 1611 from the subsidy historical information table 1610. The settlement processing portion 1400 then adds the amounts indicated in the list price 1616 of the records to calculate a total of list prices. The settlement processing portion 1400 then multiplies the calculated total of list prices of each of the registered companies by the fee rate to calculate a management fee of each of the registered companies. For example, in a case where the fee rate is “3.0%”, the settlement processing portion 1400 calculates the management fee by multiplying the total amount by “0.03”.

The settlement processing portion 1400 then refers to the subsidy historical information table 1610 (see FIG. 8) and calculates the total amount of subsidy for each of the registered shops (Step S63). To be specific, for each of shop IDs indicated in the shop ID 1551 of the registered shop information table 1550 (see FIG. 7), the settlement processing portion 1400 reads out, from the subsidy historical information table 1610, records each of which has the shop ID in the shop ID 1614. The settlement processing portion 1400 then adds the amount indicated as the subsidy amount 1617 in each of the records thus read out, and calculates the total amount of subsidy.

The settlement processing portion 1400, which has calculated the total amount of subsidy for each of the registered shops, calculates a management fee for each of the registered shops (Step S64). To be specific, the settlement processing portion 1400 reads out the fee rate indicated in the management fee 1532 of a record having a “shop” as the target 1531 of the management fee information table 1530 (see FIG. 5). For each of the shop IDs indicated in the shop ID 1551 of the registered shop information table 1550, the settlement processing portion 1400 reads out, from the subsidy historical information table 1610, records each of which has the shop ID in the shop ID 1614. The settlement processing portion 1400 then adds amounts indicated in the list price 1616 of the records thus read out and calculates a total of list prices. The settlement processing portion 1400 then multiplies the calculated total of list prices of each of the registered shops by the fee rate to calculate a management fee of each of the registered shops.

The settlement processing portion 1400 then calculates a billing amount for each of the registered companies to inform the company server device 2000 of each of the registered companies of the billing amount (Step S65). The amount billed to the registered company is an amount calculated by adding the management fee to the total amount of subsidy.

In the company server device 2000, the settlement processing portion 2300 is informed of the billing amount, performs processing for transferring the billing amount to the account of the management company, and sends, after the transfer, a notice of the transfer completion to the management server device 1000 (Step S67).

In the management server device 1000, the settlement processing portion 1400 also calculates a transfer amount for each of the registered shops, performs processing for transferring to an account of each of the registered shops, and sends, after the transfer, a notice of the transfer completion to the shop terminal 4000 (Step S66). The amount to be transferred to an account of the registered shop is an amount calculated by subtracting the management fee from the total amount of subsidy. If the amount calculated by subtracting the management fee from the total amount of subsidy is a negative amount, then the settlement processing portion 1400 charges the negative amount to the corresponding registered shop.

In the shop terminal 4000, the control unit 4100 receives the notice of the transfer completion, performs processing for displaying the truth in the display, and so on (Step S68).

As described above, even if the employee of the registered company has a meal by freely selecting a registered shop (restaurant) and a dish depending on the mood and location on the day, he/she is allowed to receive subsidy for meal. The registered company can offer food-related employee benefits service, for example, can take care of employees' health without securing a place and budget for installing and managing a company cafeteria. Enhancing the level of employee benefits leads to increase in employee loyalty to the company, resulting in reduction in the rate of turnover. This may also lead to the hiring of outstanding personnel. The registered shops can expect customers from registered companies. If the registered shops offer good service, then more customers come to the shops through word of mouth of employees. This also may lead to increase the customer unit price.

### Second Embodiment

In the first embodiment, when paying for food and drink, an employee pays an amount calculated by subtracting the amount of subsidy depending on the food and drink expenses. Instead of this, however, another configuration is possible in which the amount of subsidy depending on the expenses is paid from a company to the employee.

### Example of Use

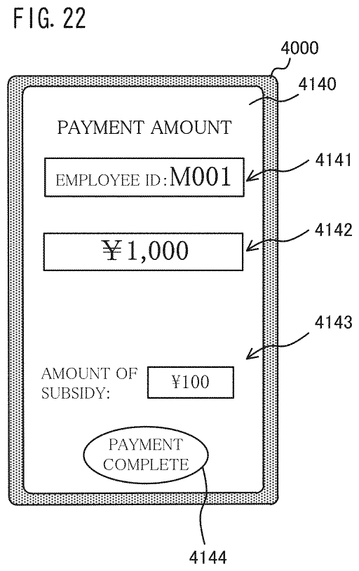

The description goes on to an example of use in the second embodiment with reference to FIG. 22. As with the example of use of the first embodiment, it is supposed that an employee 200 of a registered company has lunch at one of registered shops.

When paying a restaurant worker 400 for the price, the employee 200 makes a barcode image 3001 visible on a screen of an employee terminal 3000 carried by the employee 200 and shows the barcode image 3001 to the restaurant worker 400.

The restaurant worker 400 uses a shop terminal 4000 to log into a support system 100 and photographs the barcode image 3001 of an employee identification screen 3120.

In response to the restaurant worker 400 photographing the barcode image 3001, the expenses (list price) are displayed as a payment amount in the shop terminal 4000.

FIG. 22 is a diagram showing an example of a shop checkout screen according to the second embodiment.

A shop checkout screen 4140 has an employee ID 4141, a payment amount 4142, and subsidy information 4143. As the employee ID 4141, an employee ID of the employee 200 is displayed. As the payment amount 4142, the list price of food and drink to be paid by the employee 200 is displayed. As the subsidy information 4143, the amount of subsidy that the employee 200 is to receive is displayed. A difference from the shop checkout screen 4130 (see (b) of FIG. 18) of the first embodiment is that the payment amount 4142 is the list price. Based on the difference, no list price is displayed in the subsidy information 4143.

The employee 200 confirms that his/her employee ID is displayed in the shop checkout screen 4140, and pays the list price displayed as the payment amount 4142 to the restaurant worker 400. The restaurant worker 400 receives the payment and presses a payment complete button 4144.

The total amount of subsidy for the previous month is transferred from the company to an account of the employee on his/her payday.

As described above, the support system 100 enables the restaurant to provide lunch with almost the same effort as that in usual calculation processing, enables the employee to have lunch in an easy manner such as showing his/her ID, and enables the company to give the employee 200 the subsidy for lunch.

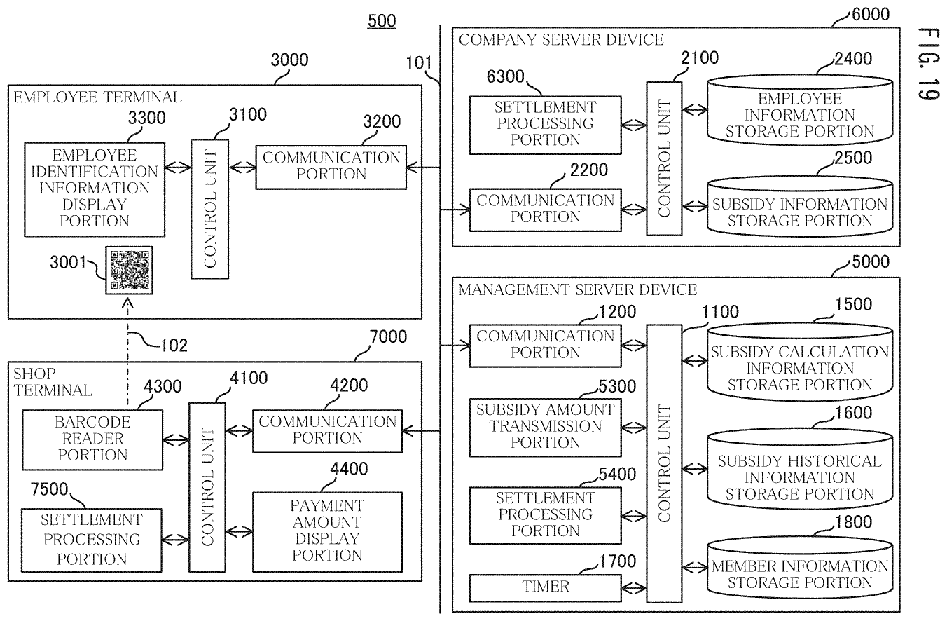

FIG. 19 is a functional block diagram of each device of a support system 500 for paying the amount of subsidy depending on the food and drink expenses of an employee from a company to the employee.

### Configuration

The configuration of the support system 500 is different from the configuration of the support system 100 in that: a management server device 5000 of the support system 500 includes a subsidy amount transmission portion 5300 instead of the payment amount transmission portion 1300 included in the management server device 1000 of the support system 100; the management server device 5000 includes a settlement processing portion 5400 instead of the settlement processing portion 1400 included in the management server device 1000; a company server device 6000 of the support system 500 includes a settlement processing portion 6300 instead of the settlement processing portion 2300 included in the company server device 2000 of the support system 100; and a shop terminal 7000 of the support system 500 includes a settlement processing portion 7500 instead of the functional portion included in the shop terminal 4000 of the support system 100.

When data is received from the shop terminal 7000, the subsidy amount transmission portion 5300 of the management server device 5000 calculates the amount of subsidy and sends, to the shop terminal 7000, indicative data on the shop checkout screen 4120 in which the calculated amount of subsidy is displayed.

The settlement processing portion 5400 calculates, on a settlement date, a management fee to be charged to each of the registered companies, sends data on the management fee and the subsidy history to the company server device 2000 of each of the registered companies, calculates a management fee to be charged to each of the registered shops, and sends the management fee to the shop terminal 7000 of each of the restaurants.

When a monthly billing amount (management fee) sent by the management server device 5000 is received, the settlement processing portion 6300 of the company server device 6000 performs processing for transferring to the account of the management company of the support system 500. After the transfer, the settlement processing portion 6300 informs the management server device 5000 of the completion of the billing amount payment. The settlement processing portion 6300 also calculates the amount of subsidy that each employee is to receive based on the data on the subsidy history sent by the management server device 5000, and then transfers the subsidy to an account of each employee as needed.

In the shop terminal 7000, the settlement processing portion 7500 receives the monthly billing amount (management fee) sent by the management server device 5000, performs processing for transferring to the account of the management company of the support system 500. After the transfer, the settlement processing portion 7500 informs the management server device 5000 of the completion of the billing amount payment.

### Operation

### Payment Processing

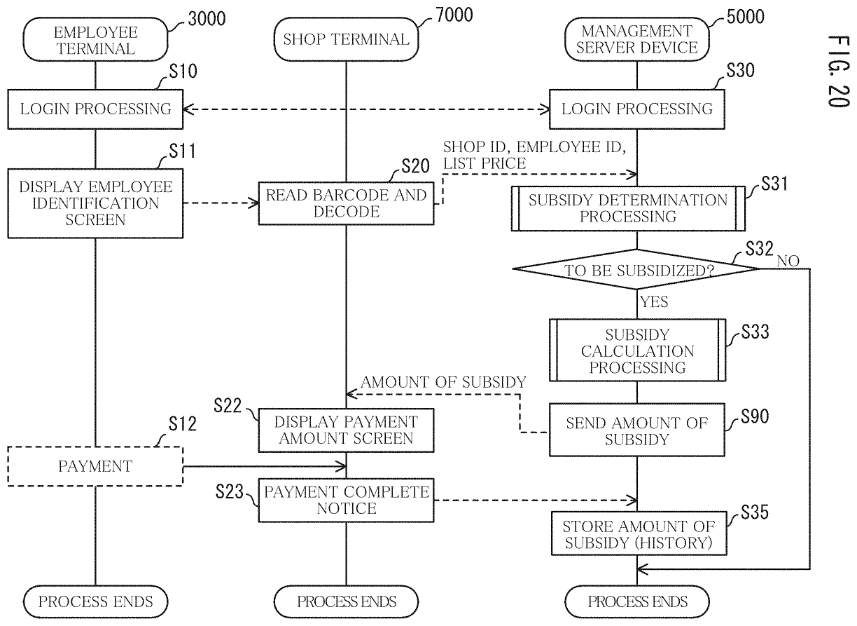

The payment processing of the second embodiment is described with reference to FIG. 20. FIG. 20 is a flowchart depicting the payment processing.

The payment processing of FIG. 20 is similar to that in the flowchart of FIG. 12. The payment processing of FIG. 20 is different from that of FIG. 12 in that the processing of Step S90 is performed instead of the processing of Step S34.

The payment amount transmission portion 1300 generates indicative data for displaying the shop checkout screen 4140 (see FIG. 22) in which the amount of subsidy for the target meal calculated in the processing of Step S33 is displayed, and sends the indicative data thus generated to the shop terminal 7000 of a restaurant identified by a target shop ID.

When the indicative data is received from the management server device 5000, the payment amount display portion 4400 of the shop terminal 7000 displays the shop checkout screen 4140 in which the payment amount is displayed (Step S22).

### Settlement Processing

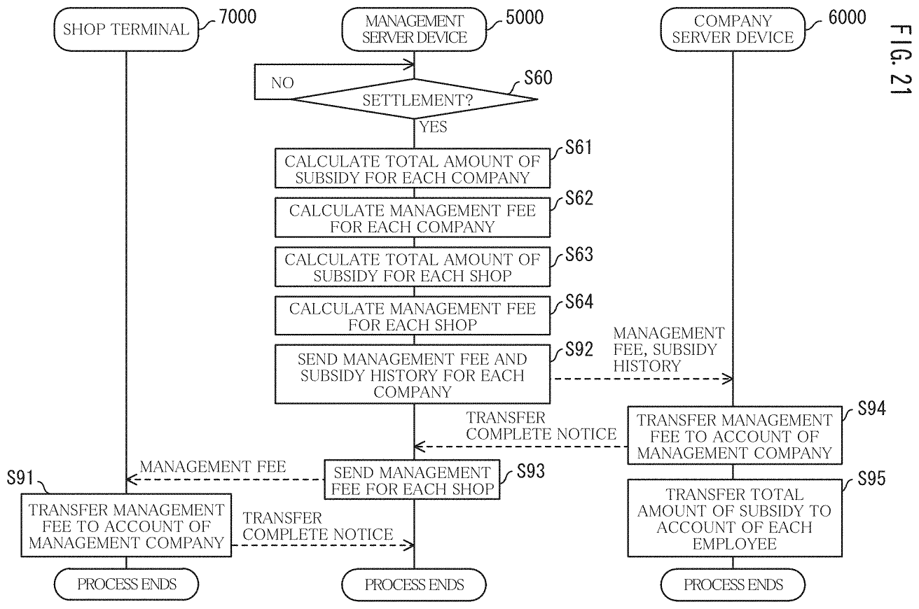

The description goes on to the settlement processing according to the second embodiment with reference to FIG. 21. FIG. 21 is a flowchart of the settlement processing.

The settlement processing of FIG. 21 is similar to that of FIG. 15 except that, instead of the processing of Step S65 and beyond of FIG. 15, the processing of Step S92 and beyond is provided.

In the processing from Step S60 through Step S64, the settlement processing portion 5400 calculates a management fee of each of the registered companies, and a management fee of each of the registered shops. The settlement processing portion 5400 sends the amount of the calculated management fee and the subsidy historical data to the company server device 6000 of each of the registered companies (Step S92). The subsidy historical data is the subsidy historical information table 1610 in which a company ID of the destination registered company is indicated as the company ID 1611.

In the company server device 6000, the settlement processing portion 6300 is informed of the monthly billing amount and the subsidy historical data, and performs processing for transferring the management fee to the account of the management company. After the transfer, the settlement processing portion 6300 sends a notice of the transfer completion to the management server device 5000 (Step S94).

The settlement processing portion 6300 also refers to the subsidy historical data, calculates, for each employee, the total amount of subsidy, and transfers to an account of each employee (Step S95). To be specific, regarding each of the employee IDs set as the employee ID 2411 in the employee information table 2410 (see FIG. 9) stored in the employee information storage portion 2400, the settlement processing portion 6300 reads out, from the subsidy historical information table 1610, a record in which the corresponding employee ID is indicated as the employee ID 1613. The settlement processing portion 6300 then adds up amounts that are indicated in the subsidy amount 1617 of each of the records thus read out, and calculates the total amount of subsidy.

In the management server device 5000, the settlement processing portion 5400 sends the amount of the calculated management fee to the shop terminal 7000 of each of the registered shops (Step S93). In the shop terminal 7000, the settlement processing portion 7500 receives the amount of the management fee and performs processing for transferring the management fee to the account of the management company. After the transfer, the settlement processing portion 7500 sends a notice showing that the transfer has been made to the management server device 5000 (Step S91).

### Third Embodiment

In the second embodiment, an employee pays food and drink expenses at a registered shop, and at a later date, the amount of subsidy according to the expenses is automatically calculated and paid from a company to the employee. Instead of this, however, another configuration is possible in which an employee reports the food and drink expenses paid to the shop, and the amount of subsidy according to the expenses is paid to the employee at a later date. In the third embodiment, the employee sends an image of a receipt for the food and drink expenses or the like to the management server device of the support system and the company pays the amount of subsidy according to the expenses to the employee at a later date.

### Configuration

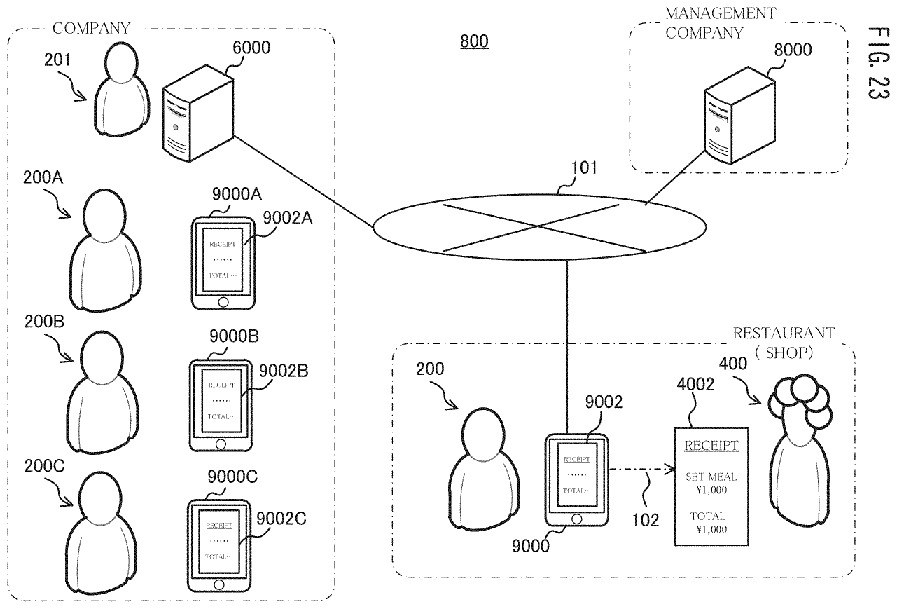

FIG. 23 is a diagram showing an example of the configuration of a support system 800 according to the third embodiment. The support system 800 includes a management server device 8000, a company server device 6000, and an employee terminal 9000. Unlike the support system 100 of the first embodiment and the support system 500 of the second embodiment, the support system 800 does not include the shop terminal 4000.

The company server device 6000 and the employee terminal 9000 are connected to the management server device 8000 via a network 101 that is a wide-area network such as a network provided by a telecommunications carrier or the Internet. A dot-dash line 102 shows image capturing.

The management server device 8000 is managed by a management company that operates the support system 800. The management server device 8000 is a so-called server for supporting (assisting) employee benefits of a company. The company server device 6000 is a processing device such as a personal computer owned by a company registered in the support system 800.

It is supposed that the employee terminal 9000 has an application (“report application”) downloaded thereto in advance in order to photograph a receipt 4002 and to report to the management server device 8000.

### Example of Use

The description goes on to an example of use in the third embodiment with reference to FIG. 23. It is supposed that an employee 200 of a registered company has lunch at one of restaurants (not necessarily a registered shop) in a town.

The employee 200 pays a restaurant worker 400 the expenses (list price), and receives a receipt 4002 for payment.

When the employee 200 starts the report application of the employee terminal 9000 to photograph the receipt 4002, a report confirmation screen 9110 is displayed.

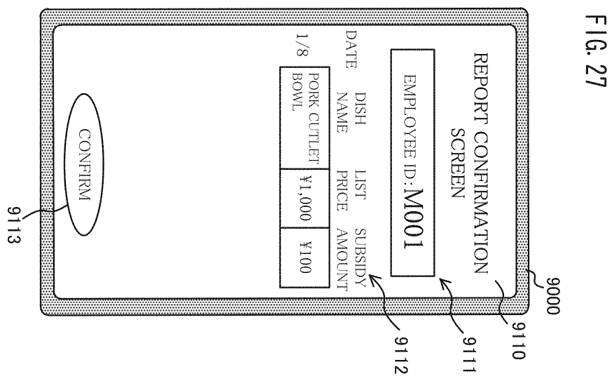

FIG. 27 shows an example of the report confirmation screen 9110.

The report confirmation screen 9110 has an employee ID 9111, report details 9112, and a confirm button 9113. As the employee ID 9111, an employee ID of the employee 200 is displayed. As the report details 9112, the date of the receipt 4002, dish name, list price, and the amount of subsidy are displayed.

The employee 200 confirms that his/her employee ID is displayed and lunch he/she has had is indicated as the dish name in the report confirmation screen 9110. The employee 200 then presses the confirm button 9113.

On the payday of the employee, the total amount of subsidy of the previous month is transferred from the company to an account of the employee.

As described above, the support system 800 enables the company to give the employee subsidy for lunch in an easy manner such as only photographing the receipt 4002.

It is supposed that the report application is started in this embodiment; however, it is possible that access is made to a website of the support system 800 to log thereinto.

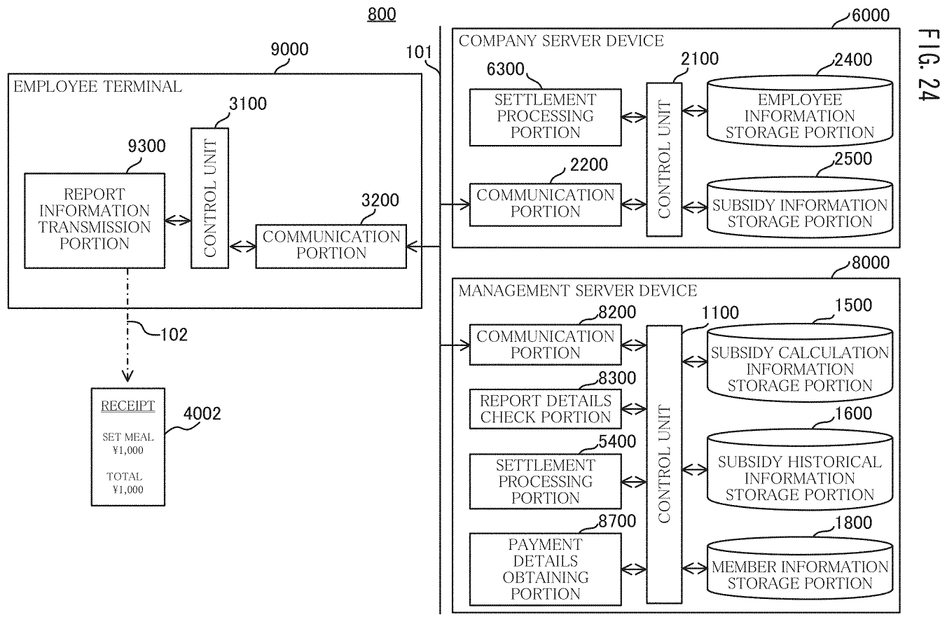

FIG. 24 is a block diagram showing the functions of the devices of the support system 800 with which the amount of subsidy is paid from a company to an employee according to the food and drink expenses reported by the employee.

### Configuration

The configuration of the support system 800 is different from the configuration of the support system 500 in that: the support system 800 does not include the shop terminal 4000; the employee terminal 9000 of the support system 800 includes a report information transmission portion 9300 instead of the employee identification information display portion 3300 provided in the employee terminal 3000 of the support system 500; the management server device 8000 of the support system 800 includes a communication portion 8200 instead of the communication portion 1200 provided in the management server device 5000 of the support system 500; the management server device 8000 includes a report details check portion 8300 instead of the subsidy amount transmission portion 5300; and the management server device 8000 includes a payment details obtaining portion 8700 instead of the timer 1700.

The report information transmission portion 9300 of the employee terminal 9000 has a camera to photograph the receipt 4002, and sends report data including the photographed image and information necessary to calculate subsidy to the management server device 8000. The information necessary to calculate subsidy is, for example, employee identification information, specifically, an employee ID of an employee who is an owner of the subject employee terminal 9000, and so on. The function of the report application is implemented by a functional portion of the employee terminal 9000.

The communication portion 8200 of the management server device 8000 performs communication with the company server device 6000 and the employee terminal 9000 via the network 101.

When report data is received from the employee terminal 9000, the report details check portion 8300 requests the payment details obtaining portion 8700 to obtain payment details, calculates the amount of subsidy based on the obtained payment amount, and sends, as the report details, the payment details and the amount of subsidy to the employee terminal 9000. For example, the report details check portion 8300 creates data for displaying the report confirmation screen 9110 to send the data created.

The payment details obtaining portion 8700 obtains the date and time, dish name, and list price from the image of the receipt 4002 included in the report data received from the employee terminal 9000. To be specific, the payment details obtaining portion 8700 uses character recognition software to extract a character string from the image of the receipt 4002, and estimates the date and time, dish name, and list price from the extracted character string. For example, the payment details obtaining portion 8700 determines a character string that probably represents a dish name based on the extract position. For example, if the dish name thus determined includes a preset character string, such as a character string such as “set meal” or “bento/packed meal”, then the payment details obtaining portion 8700 determines that the character string represents the name of a dish that the employee has eaten/drunk. Stated differently, what is to be subsidized can be selected. It is assumed, for example, that only food and drink is to be subsided and magazines and so on are not to be subsidized.

Another configuration is possible in which an operator (person) makes a visual confirmation on the image of the receipt 4002, and enters the date and time, dish name, and list price into the management server device 8000 to allow the payment details obtaining portion 8700 to obtain the date and time, dish name, and list price. Alternatively, the operator may look at the image of the receipt 4002 to modify, if necessary, the date and time, dish name, and list price determined based on the character string extracted by the character recognition software.

### Operation

### Report Processing

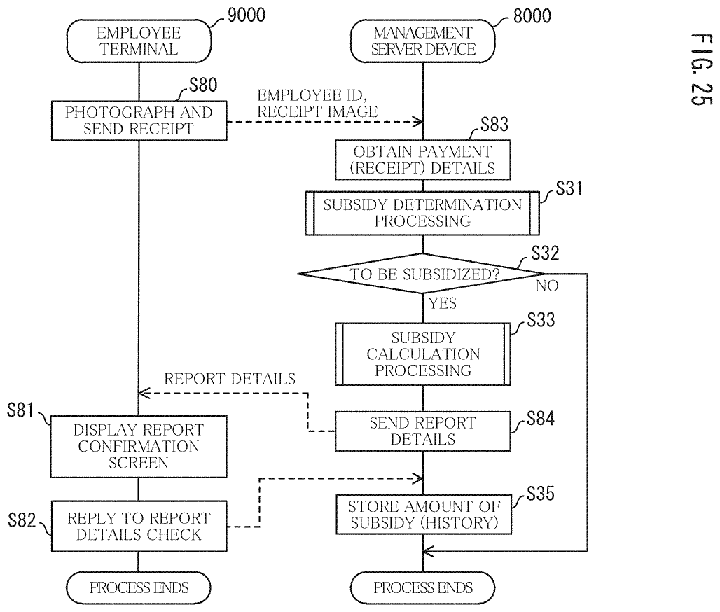

The description goes on to the report processing of the third embodiment. FIG. 25 is a flowchart of the report processing. In FIG. 25, an arrow indicated by a broken line shows the flow of data.

An employee 200 of a registered company has a meal in a restaurant that is a registered shop, pays a restaurant worker 400 for food and drink, and receives a receipt 4002.

The employee 200 launches the report application of the employee terminal 9000. It is supposed that, in the report application, login information is entered by a user in advance on a login screen to the support system 100 and that an employee ID and a password, which are the login information, are stored.

The control unit 3100, which has detected the operation for launching the report application, requests the report information transmission portion 9300 to perform the report processing. The report information transmission portion 9300 receives the request, obtains data necessary for report, and sends the obtained data to the management server device 8000 (Step S80).

To be specific, the report information transmission portion 9300, which has been requested to perform the report processing, first starts the camera. The employee 200 takes a photograph of the receipt 4002. The report information transmission portion 9300 captures an image of the receipt 4002, reads out the employee ID and the password stored in the report application, and then sends the same, as the report data, together with the image of the receipt 4002 to the management server device 8000.

The management server device 8000 receives the report data from the employee terminal 9000. The control unit 1100 conveys the received report data to the report details check portion 8300 thus requested to request the same to check the report details. The report details check portion 8300 thus requested conveys the received image of the receipt 4002, and requests the payment details obtaining portion 8700 to obtain the report details. The payment details obtaining portion 8700 then obtains the date and time, dish name, and list price from the image of the receipt 4002, and conveys the date and time, dish name, and list price to the report details check portion 8300.

The report details check portion 8300 receives the date and time, dish name, and list price, and determines whether a meal corresponding to the received data (hereinafter, referred to as a “target meal”) is to be subsidized with reference to the data stored in the subsidy calculation information storage portion 1500 (Step S31).

If determining that the target meal is to be subsidized (Step S32: YES), then the report details check portion 8300 calculates the amount of subsidy for the target meal with reference to the data stored in the subsidy calculation information storage portion 1500 (Step S33).

The report details check portion 8300 then creates indicative data for displaying the report confirmation screen 9110 (see FIG. 27) and sends the indicative data thus created to the employee terminal 9000 (Step S84).

When the indicative data is received from the management server device 8000, the control unit 3100 of the employee terminal 9000 displays the report confirmation screen 9110 showing the report details (Step S81).

The employee 200 confirms the report details displayed in the report confirmation screen 9110 to press the confirm button 9113. The control unit 3100 detects the confirm button 9113 pressed, and informs the management server device 8000 of the fact (Step S82).

In the management server device 8000, when being informed that the confirmation has been made, the report details check portion 8300 generates a record based on the data on report details, adds the generated record to the subsidy historical information table 1610 (see FIG. 8) (Step S35), and finishes the processing. To be specific, the report details check portion 8300 generates a record by setting: a company ID of the report data as the company ID 1611; the date and time of the report details as the date and time 1612; the employee ID of the report data as the employee ID 1613; the dish name of the report details as the dish name 1615; the list price of the report details as the list price 1616; the amount of subsidy calculated in the processing of Step S33 as the subsidy amount 1617; the type of a meal determined in the processing of Step S30 as the subsidized meal 1618. The report details check portion 8300 then adds the generated record to the subsidy historical information table 1610.

In Step S31, when determining that the target meal is not to be subsidized (Step S32: NO), the report details check portion 8300 informs the employee terminal 9000 of the fact, and finishes the processing.

### Settlement Processing

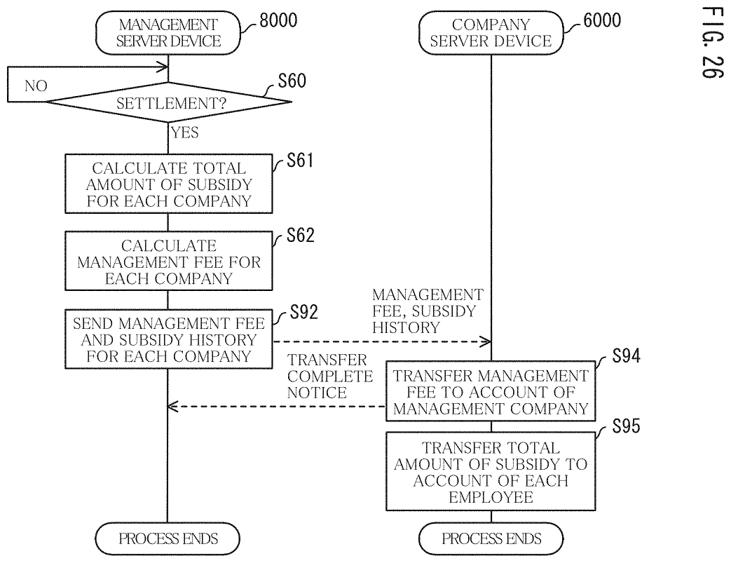

The description goes on to the settlement processing according to the third embodiment with reference to FIG. 26. FIG. 26 is a flowchart depicting the settlement processing.

The settlement processing is similar to that of the flowchart in FIG. 21 except that the settlement processing of FIG. 26 does not have the processing to be performed by the shop terminal 7000 of FIG. 21 and does not have the processing of Steps S63, S64, and S93 to be performed by the management server device 5000 of FIG. 21.

Stated differently, the settlement processing in the third embodiment is performed only between the management server device 5000 and the company server device 6000. The settlement processing portion 5400 of the management server device 5000 sends the calculated amount of management fee and the subsidy historical data to the company server device 6000 of each of the registered companies (Step S92).

When the amount of management fee and the subsidy historical data are received, the settlement processing portion 6300 of the company server device 6000 performs processing for transferring the management fee to the account of the management company, and after the transfer, informs the management server device 5000 that the transfer has been completed (Step S94).

The settlement processing portion 6300 then calculates the total amount of subsidy for each employee with reference to the subsidy historical data, and transfers to an account of each employee (Step S95).

As described above, according to the third embodiment, an employee of a registered company can receive subsidy for meal only by taking an image of the receipt 4002. The registered company can offer food-related employee benefits service to employees without securing a place and budget for installing and managing a company cafeteria.

### Supplemental Remarks

(1) In the embodiments, the barcode image 3001 (employee identification information) is displayed in the employee terminal 3000 carried by the employee 200 of the registered company, and the shop terminal 4000 takes a photograph of the barcode image 3001, so that employee authentication is performed. Instead of this, however, another method may be used to perform authentication.

Instead of the employee terminal 3000, a printed matter such as an employee ID on which the barcode image 3001 is printed may be used.

Instead of making a barcode image visible, another configuration is possible in which employee identification information is stored in an IC tag (wireless tag) and so on, and the shop terminal 4000 has an IC tag reader to read the employee identification information. For example, it is possible to use the employee terminal 3000 having an IC tag in which the employee identification information is stored or a card having such an IC card. For communication with the IC tag, near field communication such as Near Field Radio Communication (NFC), Bluetooth (registered trademark), and so on are used.

Another configuration is possible in which the employee identification information is stored in a magnetic medium. For example, instead of the employee terminal 3000, it is possible to use a card having a magnetic tape in which the employee identification information is recorded.

For communication with the employee terminal 3000, a wireless Local Area Network (LAN) using infrared rays or radio wave may be used.

Another configuration is possible in which, instead of a barcode, an image created by encoding in some manner is used. In such a case, the shop terminal 4000 is provided with a decoding means corresponding to the manner. It is also possible to use an employee ID (number) itself or an image showing numbers obtained by encrypting the employee number or so. In such a case, the shop terminal 4000 or the management server device 1000 is provided with character recognition software to extract a character string of the employee ID.

(2) In the embodiments, an employee ID that is employee identification information is used to identify (authenticate) an employee. The employee identification information is not limited to information represented in numbers and characters. The employee identification information may be biometrics information with which an employee is identifiable, such as a fingerprint, iris of the pupil of eye, vein, voice print, facial form, and handwriting. In such a case, the shop terminal 4000 is provided with a means for detecting the corresponding biometrics information.

(3) In the embodiments, the employee terminal 3000 receives, from the management server device 1000, indicative data on the employee identification screen 3120 in which the barcode image 3001 is displayed. Instead of this, the employee terminal 3000 may store, in advance, data for displaying the barcode image 3001 and so on.

(4) In the embodiments, the type of a meal to be subsidized is determined. Instead of this, the number of times of subsidy per day may be determined. In such a case, for example, an item “number of times” is provided in the subsidy calculation information table 1510. Then, the payment amount transmission portion 1300 refers to the number of times and determines whether to subsidize a meal in the subsidy determination processing (see Step S31 of FIG. 12).

(5) In the embodiments, the employee identification screen 3120 is displayed in the employee terminal 3000. In addition thereto, other information related to the support system 100 may be displayed in the employee terminal 3000. For example, a usage history list, a list of registered shops, shop information, and so on are displayed in the employee terminal 3000. For example, a registered shop found out by search in accordance with conditions entered by the employee 200 is displayed in the employee terminal 3000. In such a case, the management server device 1000 reads out the subsidy historical information table 1610 or the registered shop information table 1550 (see FIG. 7), edits the same if necessary, and sends the resultant to the employee terminal 3000. Another configuration is possible in which a registered shop near the current location of the employee terminal 3000 may be displayed in the employee terminal 3000. In such a case, the employee terminal 3000 is provided with a Global Positioning System (GPS) to inform the management server device 1000 of the current location of the subject employee terminal 3000. The management server device 1000 reads out, from the registered shop information table 1550, shops that are located within a predetermined distance away from the current location received and informs the employee terminal 3000 of the shops.

(6) According to the embodiments, in the settlement processing of FIG. 15, the management server device 1000 informs the company server device 2000 of the billing amount (Step S65). Instead of this, the billing amount may be informed to the company by another method. For example, a person who is in charge in the management company informs a person who is in charge in the company via email, or alternatively, sends an invoice to the person who is in charge in the company. The company server device 2000 sends a transfer completion notice to the management server device 1000 (Step S67). Instead of this, the notice may be sent by another method, or, alternatively, it may be unnecessary to send the notice. For example, if the transfer deadline is set, the person who is in charge in the management company is simply required to check the transfer, or the like. Further, the management server device 1000 sends the transfer completion notice to the shop terminal 4000 (Step S68). Instead of this, another method may be used. For example, the fact that the transfer has been completed is informed, via email, to a person who is in charge in the shop, or, the completion notice is sent by post. As with the foregoing, in the settlement processing of FIG. 20, the management server device 5000 informs the company server device 6000 of the management fee and so on (Step S92), and the management server device 5000 sends the management fee to the shop terminal 7000 (Step S93). Instead of this, another method may be used.

In the embodiments, a history of meals that are determined not to be subsidized is not stored (Step S32: NO in FIG. 12). Instead of this, it is possible to store such a history as a history of meals which have not been subsidized.

(7) In the second and third embodiments, the subsidy historical information table 1610 is sent to a company. In the first embodiment also, it is possible to send the subsidy historical information table 1610 to a company. This allows the company to take care of employees' health by using the received subsidy historical information table 1610 and the employee information table 2410. For example, the company receives information on age of employees and names of dishes that the employees have eaten. This enables the company to provide each employee with information on nutrition of food related to meal.

(8) In the first embodiment, the management server device 1000 sends, to the shop terminal 4000, a payment amount calculated by subtracting the amount of subsidy from the list price. Instead of this, another configuration is possible in which the amount of subsidy is informed to the shop terminal 4000, and the shop terminal 4000 calculates the payment amount by subtracting the amount of subsidy from the list price.

(9) One system may be configured to support the first embodiment and the third embodiment. One system may be configured to support the second embodiment and the third embodiment. To be specific, in a case where the employee 200 fails to present the barcode image 3001 in a registered shop, the employee 200 reports by using the receipt 4002 to receive the amount of subsidy by transfer.

(10) In the third embodiment, the receipt 4002 per meal is used for reporting. Instead of this, the receipt 4002 for a plurality of times of meal may be used for reporting.

(11) In the second and third embodiments, the total amount of subsidy is transferred to an account of each employee; however, this is not limited to money. For example, it is possible to give points, which can be used for a predetermined purpose, instead of money. For example, when a predetermined number of points are saved, an employee can be given another employee benefits service. In such a case, for example, each company gives each employee points which are determined for each company in accordance with the total amount of subsidy.

(12) In the embodiments, the meal expenses and the amount of subsidy are paid in normal currency (Japanese monetary currency unit) “yen”. Instead of this, any other currency unit may be used for payment. Alternatively, electronic money such as a virtual currency may be used for payment. For example, in the first embodiment, where the meal expenses are indicated in “dollar”, the subsidy is calculated also in “dollar”. In the second and third embodiments, even when the price of meal is indicated in “yen”, the subsidy may be converted to “dollar” or predetermined virtual currency for calculation.

(13) In the embodiments, the restaurant worker 400 uses the shop terminal 4000 to read in the barcode image 3001. Another configuration is possible in which a vending machine for drinking water and so on has a function similar to that of the shop terminal 4000, and the user causes the vending machine to read the barcode image 3001. In such a case, for example, the user causes the vending machine to read the barcode image 3001 and selects an item, a payment amount calculated by subtracting the amount of subsidy from a list price is displayed in a display portion of the vending machine. The user pays the payment amount thus displayed to buy drinking water and so on.

While embodiments of the present invention have been appropriately described above with reference to drawings, the skilled person should understand that changes and modifications of the example of the invention may be made easily. Thus, it is intended to cover all changes and modifications of the example of the invention herein chosen for the purposes of the disclosure, which do not constitute departures from the spirit and scope of the invention.

### REFERENCE SIGNS LIST

100, 500, 800 support system

1000, 5000, 8000 management server device

1300 payment amount transmission portion

1400, 5400 settlement processing portion

1500 subsidy calculation information storage portion

1600 subsidy historical information storage portion

1800 member information storage portion

2000, 6000 company server device

2300, 6300 settlement processing portion

2400 employee information storage portion

2500 subsidy information storage portion

3000, 9000 employee terminal

3001 barcode image

3120 employee identification screen

3300 employee identification information display portion

4000, 7000 shop terminal

4002 receipt

4110, 4120 shop amount entry screen

4300 barcode reader portion

4400 payment amount display portion

7500 settlement processing portion

8300 report details check portion

8700 payment details obtaining portion

9110 report confirmation screen

9300 report information transmission portion

1. A support system comprising:
a service provider terminal owned by a service provider that provides a user with a predetermined item or service; and
a server device configured to perform communication with the service provider terminal, wherein
the service provider terminal includes
an obtaining means configured to obtain, from the user, a user identifier for identifying the user, and
a first transmission means configured to send, to the server device, the user identifier obtained by the obtaining means, a service amount that is a price of the predetermined item or service, and a service provider identifier for identifying the service provider, and
the server device includes
a first storage means configured to store the user identifier and subsidy calculation information in correlation with each other in advance,
a subsidy determination means configured to determine, in response to the user identifier, the service amount, and the service provider identifier received from the service provider terminal, whether to subsidize the predetermined item or service based on a time at which the pieces of data are received, and
a second transmission means configured to calculate, when the subsidy determination means determine the predetermined item or service to be subsidized, an amount of subsidy by using the received service amount and the subsidy calculation information stored in correlation with the received user identifier in the first storage means, and send, to the service provider terminal, the calculated amount of subsidy or a payment amount obtained by subtracting the calculated amount of subsidy from the received service amount.

2. The support system according to claim 1, wherein
the first storage means store, in correlation with the user identifier, an organization identifier for identifying an organization to which a user indicated by the user identifier belongs, and
the server device further includes
a second storage means configured to store, in correlation with the service amount and the amount of subsidy, the user identifier and the service provider identifier received from the service provider terminal, and
a total calculation means configured to calculate, for each organization identifier, an organization subsidy total amount that is a total amount of the subsidy stored in correlation and an organization list price total amount that is a total of service amounts, and calculate, for each service provider identifier, a provider subsidy total amount that is a total amount of the subsidy stored in correlation and a provider list price total amount that is a total of service amounts.

3. The support system according to claim 2, wherein the server device further includes a settlement means configured to calculate an organization handling charge in accordance with each of the organization list price total amounts, add the organization handling charge to the organization subsidy total amount to calculate a billing amount to be billed to an organization indicated by each of the organization identifiers, calculate a provider handling charge in accordance with each of the provider list price total amounts, and subtract the provider handling charge from the provider subsidy total amount to calculate a payment amount to a service provider indicated by each of the service provider identifiers.

4. The support system according to claim 2, wherein
the server device further includes an informing means configured to inform, of the amount of subsidy for each of the user identifiers, an organization indicated in the organization identifier stored in correlation with each of the user identifiers in the second storage means, and
the server device further includes a settlement means configured to calculate a billing amount that is an organization handling charge in accordance with each of the organization list price total amounts and is an amount to be billed to an organization indicated by each of the organization identifiers, and calculate a billing amount that is a provider handling charge in accordance with each of the provider list price total amounts and is an amount to be billed to a service provider indicated by each of the service provider identifiers.

5. The support system according to claim 1, wherein
the subsidy calculation information is a rate, and
the second transmission means calculate the rate of the service amount as the amount of subsidy.

6. The support system according to claim 1, wherein
the subsidy calculation information is a predetermined amount, and
the second transmission means calculate the predetermined amount of the service amount as the amount of subsidy.

7. The support system according to claim 1, wherein
the service provider is a restaurant, and
providing the predetermined service is to provide food and drink.

8. The support system according to claim 1, wherein
the user has a terminal with a display unit for displaying an image showing the user identifier, and
the obtaining means take a photograph of the image and obtains the user identifier from the photographed image.

9. The support system according to claim 8, wherein
the server device further stores data for displaying the image showing the user identifier, and
the terminal obtains the image from the server device and displays the image.

10. The support system according to claim 1, wherein
the user has a printed matter on which an image showing the user identifier is printed, and
the obtaining means take a photograph of the image and obtains the user identifier from the photographed image.

11. The support system according to claim 8, wherein
the image is a barcode containing encoded information including the user identifier, and
the obtaining means decode the barcode to obtain the user identifier.

12. The support system according to claim 1, wherein
the user has a wireless tag for storing the user identifier, and
the obtaining means read out the user identifier stored in the wireless tag.

13. The support system according to claim 1, wherein
the user has a magnetic medium for storing the user identifier, and
the obtaining means read out the user identifier stored in the magnetic medium.

14. The support system according to claim 1, wherein the obtaining means obtain, as the user identifier, biometrics information of the user from the user.

15. A server device of a support system including the server device and a service provider terminal that is owned by a service provider providing a user with a predetermined item or service and is configured to perform communication with the server device, the service provider terminal obtaining, from the user, a user identifier for identifying the user, and sending, to the server device, the obtained user identifier, a service amount that is a price of the predetermined item or service, and a service provider identifier for identifying the service provider, the server device comprising:
a first storage means configured to store the user identifier and subsidy calculation information in correlation with each other in advance;
a subsidy determination means configured to determine, in response to the user identifier, the service amount, and the service provider identifier received from the service provider terminal, whether to subsidize the predetermined item or service based on a time at which the pieces of data are received; and
a transmission means configured to calculate, when the subsidy determination means determine the predetermined item or service to be subsidized, an amount of subsidy by using the received service amount and the subsidy calculation information stored in correlation with the received user identifier in the first storage means, and send, to the service provider terminal, the calculated amount of subsidy or a payment amount obtained by subtracting the calculated amount of subsidy from the received service amount.

16. A support method used in a support system including a service provider terminal owned by a service provider that provides a user with a predetermined item or service and a server device configured to perform communication with the service provider terminal, the support method comprising:
performing, by the service provider terminal, an obtaining step for obtaining a user identifier for identifying the user from the user;
performing a first transmission step for sending, from the service provider terminal to the server device, the user identifier obtained in the obtaining step, a service amount that is a price of the predetermined item or service, and a service provider identifier for identifying the service provider;
providing, by the server device, a first storage means for storing the user identifier and subsidy calculation information in correlation with each other in advance;
performing, by the server device, a subsidy determination step for determining in response to the user identifier, the service amount, and the service provider identifier received from the service provider terminal, whether to subsidize the predetermined item or service based on a time at which the pieces of data are received; and
performing a second transmission step for calculating, when it is determined that the predetermined item or service is to be subsidized in the subsidy determination step, an amount of subsidy by using the received service amount and the subsidy calculation information stored in correlation with the received user identifier in the first storage means, and sending, to the service provider terminal, the calculated amount of subsidy or a payment amount obtained by subtracting the calculated amount of subsidy from the received service amount.

17. A support system comprising:
a user terminal; and
a server device configured to perform communication with the user terminal, wherein the user terminal includes
an obtaining means configured to obtain a user identifier for identifying a user,
an imaging means configured to obtain an image of a receipt in which a service amount that is a price of a predetermined item or service provided to the user and a time are indicated, and
a first transmission means configured to send the image obtained by the imaging means and the user identifier to the server device, and
the server device includes
a first storage means configured to store the user identifier, an organization identifier for identifying an organization to which the user indicated in the user identifier belongs, and subsidy calculation information in correlation with one another in advance,
a subsidy determination means configured to receive the image and the user identifier from the user terminal, extract the service amount and the time from the received image, and determine whether to subsidize the predetermined item or service based on the extracted time,
a subsidy calculation means configured to calculate, when the subsidy determination means determine the predetermined item or service to be subsidized, an amount of subsidy by using the extracted service amount and the subsidy calculation information stored in correlation with the received user identifier in the first storage means,
a second storage means configured to store the user identifier received from the user terminal in correlation with the amount of subsidy, and
an informing means configured to inform, of the amount of subsidy for each of the user identifiers, an organization indicated in the organization identifier stored in correlation with each of the user identifiers in the first storage means.

18. A server device of a support system including a user terminal that has an obtaining means for obtaining a user identifier for identifying a user and the server device communicably connected to the user terminal, the server device comprising:
a first storage means configured to store the user identifier, an organization identifier for identifying an organization to which the user indicated in the user identifier belongs, and subsidy calculation information in correlation with one another in advance;
a subsidy determination means configured to receive, from the user terminal, the user identifier and an image of a receipt in which a service amount that is a price of a predetermined item or service provided to the user and a time are indicated extract the service amount and the time from the received image, and determine whether to subsidize the predetermined item or service based on the extracted time;
a subsidy calculation means configured to calculate, when the subsidy determination means determine the predetermined item or service to be subsidized, an amount of subsidy by using the extracted service amount and the subsidy calculation information stored in correlation with the received user identifier in the first storage means;
a second storage means configured to store the user identifier received from the user terminal in correlation with the amount of subsidy; and
an informing means configured to inform, of the amount of subsidy for each of the user identifiers, an organization indicated in the organization identifier stored in correlation with each of the user identifiers in the first storage means.

19. A support method used in a support system including a user terminal and a server device configured to perform communication with the user terminal, the support method comprising:
performing, by the user terminal, an obtaining step for obtaining a user identifier for identifying a user;
performing, by the user terminal, an imaging step for obtaining an image of a receipt in which a service amount that is a price of a predetermined item or service provided to the user and a time are indicated;
performing a first transmission step for sending the image obtained in the imaging step and the user identifier from the user terminal to the server device;
providing, by the server device, a first storage means configured to store the user identifier and subsidy calculation information, an organization identifier for identifying an organization to which the user indicated in the user identifier belongs in correlation with one another in advance;
performing, by the server device, a subsidy determination step for receiving the image and the user identifier from the user terminal, extracting the service amount and the time from the received image, and determining whether to subsidize the predetermined item or service based on the extracted time;
performing, by the server device, a subsidy calculation step for calculating, when the predetermined item or service is determined to be subsidized in the subsidy determination step, an amount of subsidy by using the extracted service amount and the subsidy calculation information stored in correlation with the received user identifier in the first storage means;
performing, by the server device, a second storage step for storing the user identifier received from the user terminal in correlation with the amount of subsidy; and
performing, by the server device, an informing step for informing, of the amount of subsidy for each of the user identifiers, an organization indicated in the organization identifier stored in correlation with each of the user identifiers in the first storage means.
